(19) United States
(12) Patent Application Publication
(10) Pub. No.: US 2010/0034310 A1
(43) Pub. Date: Feb. 11, 2010

(54) Transmit diversity schemes in OFDM systems

(75) Inventors: Young-Han Nam, Plano, TX (US); Jianzhong Zhang, Irving, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/387,384

(22) Filed: May 1, 2009

Related U.S. Application Data
(60) Provisional application No. 61/188,451, filed on Aug. 8, 2008.

(51) Int. Cl. H04B 7/02

(52) U.S. Cl. 375/267

(57) ABSTRACT

A transmission diversity device is provided. The transmission diversity device includes physical channel processing configured to map a plurality of modulation symbols onto one or more layers. Thereafter a precoder is configured to perform beamforming on the one or more layers. The output of the precoder is obtained by at least one of two base equations. The mapper and precoder are configured to perform code word-to-layer mapping for transmit diversity for two layers, four layers, six layers, eight layers and sixteen layers. Further, the mapper and precoder are configured to perform code word-to-layer mapping for 8 transmit diversity schemes.

### CROSS-REFERENCE TO RELATED APPLICATION(S) AND CLAIM OF PRIORITY

The present application is related to U.S. Provisional Patent No. 61/188,451, filed Aug. 8, 2008, entitled “TRANSMIT DIVERSITY SCHEMES IN OFDM SYSTEM”. Provisional Patent No. 61/188,451 is assigned to the assignee of the present application and is hereby incorporated by reference into the present application as if fully set forth herein. The present application hereby claims priority under 35 U.S.C. §119(e) to U.S. Provisional Patent No. 61/188,451.

### TECHNICAL FIELD OF THE INVENTION

The present application relates generally to wireless communications networks and, more specifically, to diversity schemes for a wireless communication network.

### BACKGROUND OF THE INVENTION

Modern communications demand higher data rates and performance. Multiple input, multiple output (MIMO) antenna systems, also known as multiple-element antenna (MEA) systems, achieve greater spectral efficiency for allocated radio frequency (RF) channel bandwidths by utilizing space or antenna diversity at both the transmitter and the receiver, or in other cases, the transceiver.

In MIMO systems, each of a plurality of data streams is individually mapped and modulated before being precoded and transmitted by different physical antennas or effective antennas. The combined data streams are then received at multiple antennas of a receiver. At the receiver, each data stream is separated and extracted from the combined signal. This process is generally performed using a minimum mean squared error (MMSE) or MMSE-successive interference cancellation (SIC) algorithm.

### SUMMARY OF THE INVENTION

A transmission diversity device is provided. The transmission diversity device includes a number of antenna ports; a layer mapper configured to map a plurality of modulation symbols onto one or more layers; and a precoder configured to perform beamforming on the one or more layers. Further, the transmission diversity device is configured such that an output of the precoder is obtained by at least one of two base equations or an 8TxD equation, and wherein the two base equations are:

$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 2} ( i ) ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} k} & - {( {x}^{( 1 )} ( i ) )}^{*} {e}^{j {θ}_{1} k} \\ {x}^{( 1 )} ( i ) {e}^{j ( {θ}_{2} k + φ )} & {( {x}^{( 0 )} ( i ) )}^{*} {e}^{j ( {θ}_{2} k + φ )}\end{matrix} ] ; and & Equation 1 \\ [ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 3} ( i ) ≡ \frac{1}{\sqrt{4}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] . & Equation 2\end{matrix}$$

A method for transmission diversity in a wireless communications network is provided. The method includes mapping a plurality of modulation symbols onto one or more layers; and precoding the one or more layers using at least one of two equations or an 8TxD equation. The two equations are:

$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 2} ( i ) ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} k} & - {( {x}^{( 1 )} ( i ) )}^{*} {e}^{j {θ}_{1} k} \\ {x}^{( 1 )} ( i ) {e}^{j ( {θ}_{2} k + φ )} & {( {x}^{( 0 )} ( i ) )}^{*} {e}^{j ( {θ}_{2} k + φ )}\end{matrix} ] ; and & Equation 1 \\ [ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 3} ( i ) ≡ \frac{1}{\sqrt{4}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] . & Equation 2\end{matrix}$$

A wireless network is provided. The wireless network includes a number of base stations capable of diversity transmissions with a number of subscriber stations, wherein at least one of the subscriber stations includes a number of antenna ports; a layer mapper configured to map a plurality of modulation symbols onto one or more layers; and a precoder configured to perform beamforming on the one or more layers. Further, the transmission diversity device is configured such that an output of the precoder is obtained by at least one of two base equations or an 8TxD equation, and wherein the two base equations are:

$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 2} ( i ) ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} k} & - {( {x}^{( 1 )} ( i ) )}^{*} {e}^{j {θ}_{1} k} \\ {x}^{( 1 )} ( i ) {e}^{j ( {θ}_{2} k + φ )} & {( {x}^{( 0 )} ( i ) )}^{*} {e}^{j ( {θ}_{2} k + φ )}\end{matrix} ] ; and & Equation 1 \\ [ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 3} ( i ) ≡ \frac{1}{\sqrt{4}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] . & Equation 2\end{matrix}$$

A method for wireless communications is provided. The method includes mapping a plurality of modulation symbols onto at least one layer; and precoding the at least one layer using an 8TxD equation, and wherein one or more of X₁, X₂, X₃ and X₄ is defined by at least one of two equations. The two equations are:

$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 2} ( i ) ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} k} & - {( {x}^{( 1 )} ( i ) )}^{*} {e}^{j {θ}_{1} k} \\ {x}^{( 1 )} ( i ) {e}^{j ( {θ}_{2} k + φ )} & {( {x}^{( 0 )} ( i ) )}^{*} {e}^{j ( {θ}_{2} k + φ )}\end{matrix} ] ; and & Equation 1 \\ [ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 3} ( i ) ≡ \frac{1}{\sqrt{4}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] . & Equation 2\end{matrix}$$

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an Orthogonal Frequency Division Multiple Access (OFDMA) wireless network that is capable of decoding data streams according to one embodiment of the present disclosure;

FIG. 2A is a high-level diagram of an OFDMA transmitter according to one embodiment of the present disclosure;

FIG. 2B is a high-level diagram of an OFDMA receiver according to one embodiment of the present disclosure;

FIG. 3 illustrates physical channel processing according to an embodiment of the present disclosure; and

FIGS. 4-10 illustrate a layer mapper and precoder according to various embodiments of the present disclosure.

### DETAILED DESCRIPTION OF THE INVENTION

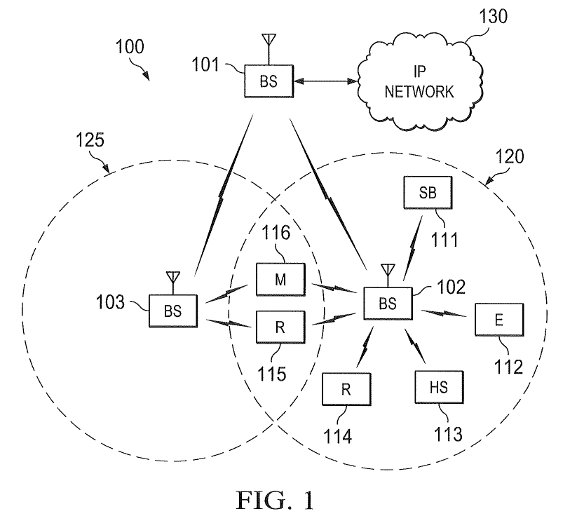

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

With regard to the following description, it is noted that the LTE term “node B” is another term for “base station” used below. Also, the LTE term “user equipment” or “UE” is another term for “subscriber station” used below.

FIG. 1 illustrates exemplary wireless network 100 that is capable of decoding data streams according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. Subscriber station (SS) may be any wireless communication device, such as, but not limited to, a mobile phone, mobile PDA and any mobile station (MS). In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet by means of a wired broadband connection, such as an optical fiber, DSL, cable or T1/E1 line, rather than indirectly through base station 101.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in handoff mode, as known to those of skill in the art.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, cafe, hotel, or college campus. Base station 102 may provide digital subscriber line (DSL) level service to subscriber stations 114, 115, 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1. In another embodiment, the connection to network 130 may be provided by different network nodes and equipment.

in accordance with an embodiment of the present disclosure, one or more of base stations 101-103 and/or one or more of subscriber stations 111-116 comprises a receiver that is operable to decode a plurality of data streams received as a combined data stream from a plurality of transmit antennas using-an MMSE-SIC algorithm. As described in more detail below, the receiver is operable to determine a decoding order for the data streams based on a decoding prediction metric for each data stream that is calculated based on a strength-related characteristic of the data stream. Thus, in general, the receiver is able to decode the strongest data stream first, followed by the next strongest data stream, and so on. As a result, the decoding performance of the receiver is improved as compared to a receiver that decodes streams in a random or pre-determined order without being as complex as a receiver that searches all possible decoding orders to find the optimum order.

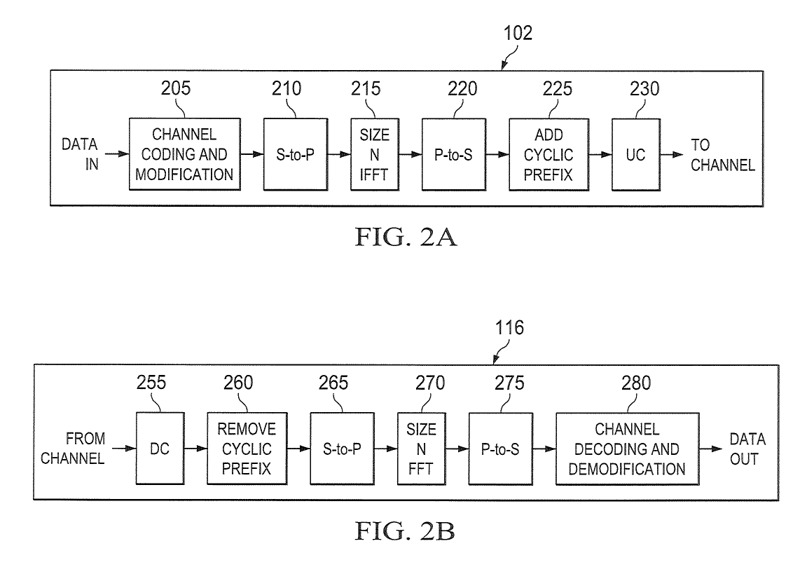

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in subscriber station (SS) 116 for the purposes of illustration and explanation only. However, it will be understood by those skilled in the art that the OFDMA receive path may also be implemented in BS 102 and the OFDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

The present disclosure describes methods and systems to convey information relating to base station configuration to subscriber stations and, more specifically, to relaying base station antenna configuration to subscriber stations. This information can be conveyed through a plurality of methods, including placing antenna configuration into a quadrature-phase shift keying (QPSK) constellation (e.g., n-quadrature amplitude modulation (QAM) signal, wherein n is 2̂x) and placing antenna configuration into the error correction data (e.g., cyclic redundancy check (CRC) data). By encoding antenna information into either the QPSK constellation or the error correction data, the base stations 101-103 can convey base stations 101-103 antenna configuration without having to separately transmit antenna configuration. These systems and methods allow for the reduction of overhead while ensuring reliable communication between base stations 101-103 and a plurality of subscriber stations.

In some embodiments disclosed herein, data is transmitted using QAM. QAM is a modulation scheme which conveys data by modulating the amplitude of two carrier waves. These two waves are referred to as quadrature carriers, and are generally out of phase with each other by 90 degrees. QAM may be represented by a constellation that comprises 2̂x points, where x is an integer greater than 1. In the embodiments discussed herein, the constellations discussed will be four point constellations (4-QAM). In a 4-QAM constellation a 2 dimensional graph is represented with one point in each quadrant of the 2 dimensional graph. However, it is explicitly understood that the innovations discussed herein may 0be used with any modulation scheme with any number of points in the constellation. It is further understood that with constellations with more than four points additional information (e.g., reference power signal) relating to the configuration of the base stations 101-103 may be conveyed consistent with the disclosed systems and methods.

It is understood that the transmitter within base stations 101-103 performs a plurality of functions prior to actually transmitting data. In the 4-QAM embodiment, QAM modulated symbols are serial-to-parallel converted and input to an inverse fast Fourier transform (IFFT). At the output of the IFFT, N time-domain samples are obtained. In the disclosed embodiments, N refers to the IFFT/fast Fourier transform (FFT) size used by the OFDM system. The signal after IFFT is parallel-to-serial converted and a cyclic prefix (CP) is added to the signal sequence. The resulting sequence of samples is referred to as an OFDM symbol.

At the receiver within the subscriber station, this process is reversed, and the cyclic prefix is first removed. Then the signal is serial-to-parallel converted before being fed into the FFT. The output of the FFT is parallel-to-serial converted, and the resulting QAM modulation symbols are input to the QAM demodulator.

The total bandwidth in an OFDM system is divided into narrowband frequency units called subcarriers. The number of subcarriers is equal to the FFT/IFFT size N used in the system. In general, the number of subcarriers used for data is less than N because some subcarriers at the edge of the frequency spectrum are reserved as guard subcarriers. In general, no information is transmitted on guard subcarriers.

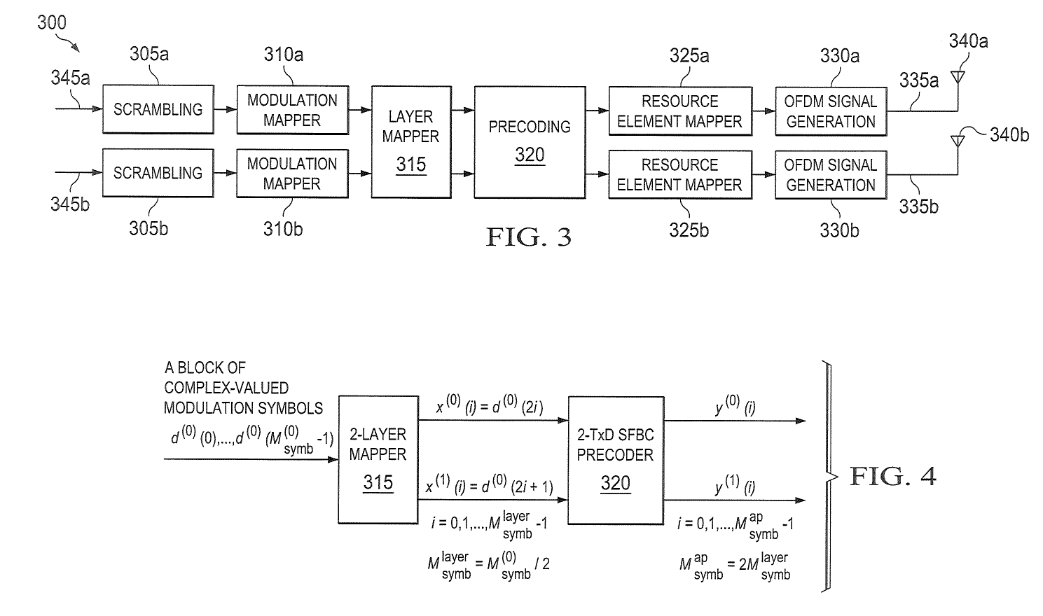

FIG. 3 illustrates details of physical channel 300 processing according to an embodiment of the present disclosure. The embodiment of the physical channel 300 shown in FIG. 3 is for illustration only. Other embodiments of the physical channel 300 could be used without departing from the scope of this disclosure.

For this embodiment, physical channel 300 comprises a plurality of scrambler blocks 305, a plurality of modulation mapper blocks 310, a layer mapper 315, a preceding block 320 (hereinafter “preceding”), a plurality of resource element mappers 325, and a plurality of OFDM signal generation blocks 330. The embodiment of the physical channel 300 illustrated in FIG. 3 is applicable to more than one physical channel. Although the illustrated embodiment shows two sets of components 305, 310, 325 and 330 to generate two streams 335a-b for transmission by two antenna ports 3405a-b, it will be understood that physical channel 300 may comprise any suitable number of component sets 305, 310, 325 and 330 based on any suitable number of streams 335 to be generated. At least some of the components in FIG. 3 may be implemented in software while other components may be implemented by configurable hardware or a mixture of software and configurable hardware.

The physical channel 300 is operable to scramble coded bits in each code word 345 to be transmitted on the physical channel 300. The plurality of scrambler blocks 305 are operable to scramble each code word 345a-345b according to Equation 1:

\tilde{b}^{q}(i)=(b^{q}(i)+c^{q}(i))mod2. [Eqn: 1]

In Equation 1, b^{(q)}(0), . . . , b^{(q)}(M_{bit}^{(q)}−1) is the block of bits for code word q, M_{bit}^{(q)} is the number of bits in code word q, and c^{q}(i) is the scrambling sequence.

The physical channel 300 further is operable to perform modulation of the scrambled bits. The plurality of modulation blocks 310 modulate the block of scrambled bits b^{(q)}(0), . . . , b^{(q)}(M_{bit}^{(q)}−1). The block of scrambled bits b^{(q)}(0), . . . , b^{(q)}(M_{bit}^{(q)}−1) is modulated using one of a number of modulation schemes including, quad phase shift keying (QPSK), sixteen quadrature amplitude modulation (16QAM), and sixty-four quadrature amplitude modulation (64QAM) for each of a physical downlink shared channel (PDSCH) and physical multicast channel (PMCH). Modulation of the scrambled bits by the plurality of modulation blocks 310 yields a block of complex-valued modulation symbols d^{(q)}(0), . . . , d^{(q)}(M_{symb}^{(q)}−1).

Further, the physical channel 300 is operable to perform layer mapping of the modulation symbols. The layer mapper 315 maps the complex-valued modulation symbols d^{(q)}(0), . . . , d^{(q)}(M_{symb}^{(q)}−1) onto one or more layers. Complex-valued modulation symbols d^{(q)}(0), . . . , d^{(q)}(M_{symb}^{(q)}−1) for code word q are mapped onto one or more layers, x(i), as defined by Equation 2:

x(i)=[x⁽⁰⁾(i) . . . x^{(ν-1)}(i)]^{T}. [Eqn. 2]

In Equation 2, i=0,1, . . . , M_{symb}^{layer}−1, ν is the number of layers and M_{symb}^{layer} is the number of modulation symbols per layer.

For transmit diversity, the layer mapping 315 is performed according to Table 1.

TABLE 1
Code word-to-layer mapping for transmit diversity

| Number of | Number of code | Code word-to-layer |
|---|---|---|
| Layers | words | mapping i = 0, 1, . . . , M_{symb}^{layer} − 1 |
| 2 | 1 | x⁽⁰⁾ (i) = d⁽⁰⁾ (2i) M_{symb}^{layer} = M_{symb}⁽⁰⁾/2 |
| | | x⁽¹⁾ (i) = d⁽⁰⁾ (2i + 1) |
| 4 | 1 | x⁽⁰⁾ (i) = d⁽⁰⁾ (4i) M_{symb}^{layer} = M_{symb}⁽⁰⁾/4 |
| | | x⁽¹⁾ (i) = d⁽⁰⁾ (4i + 1) |
| | | x⁽²⁾ (i) = d⁽⁰⁾ (4i + 2) |
| | | x⁽³⁾ (i) = d⁽⁰⁾ (4i + 3) |

In Table 1, there is only one code word. Further, the number of layers ν is equal to the number of antenna ports P used for transmission of the physical channel 300.

Thereafter, preceding 320 is performed on the one or more layers. Precoding 320 also can be used for multi-layer beamforming in order to maximize the throughput performance of a multiple receive antenna system. The multiple streams of the signals are emitted from the transmit antennas with independent and appropriate weighting per each antenna such that the link through-put is maximized at the receiver output. Precoding algorithms for multi-codeword MIMO can be sub-divided into linear and nonlinear preceding types. Linear preceding approaches can achieve reasonable throughput performance with lower complexity related to nonlinear preceding approaches. Linear precoding includes unitary precoding and zero-forcing (hereinafter “ZF”) preceding. Nonlinear preceding can achieve near optimal capacity at the expense of complexity. Nonlinear preceding is designed based on the concept of Dirty paper coding (hereinafter “DPC”) which shows that any known interference at the transmitter can be subtracted without the penalty of radio resources if the optimal preceding scheme can be applied on the transmit signal.

Precoding 320 for transmit diversity is used only in combination with layer mapping 315 for transmit diversity, as described herein above. The preceding 320 operation for transmit diversity Is defined for two and four antenna ports. The output of the preceding operation for two antenna ports (Pε{0,1})is defined by Equations 3 and 4:

y(i)=[y⁽⁰⁾(i) y⁽¹⁾(i)]^{T}. [Eqn. 3]

where:

$$[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] . \qquad [ Eqn . 4 ]$$

for i=0,1, . . . , M_{symb}^{layer}−1 with M_{symb}^{ap}=2M_{symb}^{layer}.

The output of the preceding operation for four antenna ports (Pε{0,1,2,3}) is defined by Equations 5 and 6:

y(i)=[y⁽⁰⁾(i) y⁽¹⁾(i) y⁽²⁾(i) y⁽³⁾(i)]^{T}. [Eqn. 5]

where:

$$[ \begin{matrix}{y}^{( 0 )} ( 4 i ) \\ {y}^{( 1 )} ( 4 i ) \\ {y}^{( 2 )} ( 4 i ) \\ {y}^{( 3 )} ( 4 i ) \\ {y}^{( 0 )} ( 4 i + 1 ) \\ {y}^{( 1 )} ( 4 i + 1 ) \\ {y}^{( 2 )} ( 4 i + 1 ) \\ {y}^{( 3 )} ( 4 i + 1 ) \\ {y}^{( 0 )} ( 4 i + 2 ) \\ {y}^{( 1 )} ( 4 i + 2 ) \\ {y}^{( 2 )} ( 4 i + 2 ) \\ {y}^{( 3 )} ( 4 i + 2 ) \\ {y}^{( 0 )} ( 4 i + 3 ) \\ {y}^{( 1 )} ( 4 i + 3 ) \\ {y}^{( 2 )} ( 4 i + 3 ) \\ {y}^{( 3 )} ( 4 i + 3 )\end{matrix} ] = \frac{1}{\sqrt{2}} [ \begin{matrix}1 & 0 & 0 & 0 & j & 0 & 0 & 0 \\ 0 & 0 & 0 & 0 & 0 & 0 & 0 & 0 \\ 0 & - 1 & 0 & 0 & 0 & j & 0 & 0 \\ 0 & 0 & 0 & 0 & 0 & 0 & 0 & 0 \\ 0 & 1 & 0 & 0 & 0 & j & 0 & 0 \\ 0 & 0 & 0 & 0 & 0 & 0 & 0 & 0 \\ 1 & 0 & 0 & 0 & - j & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 1 & 0 & 0 & 0 & j & 0 \\ 0 & 0 & 0 & 0 & 0 & 0 & 0 & 0 \\ 0 & 0 & 0 & - 1 & 0 & 0 & 0 & j \\ 0 & 0 & 0 & 0 & 0 & 0 & 0 & 0 \\ 0 & 0 & 0 & 1 & 0 & 0 & 0 & j \\ 0 & 0 & 0 & 0 & 0 & 0 & 0 & 0 \\ 0 & 0 & 1 & 0 & 0 & 0 & - j & 0\end{matrix} ] [ \begin{matrix}Re ( {x}^{( 0 )} ( i ) ) \\ Re ( {x}^{( 1 )} ( i ) ) \\ Re ( {x}^{( 2 )} ( i ) ) \\ Re ( {x}^{( 3 )} ( i ) ) \\ Im ( {x}^{( 0 )} ( i ) ) \\ Im ( {x}^{( 1 )} ( i ) ) \\ Im ( {x}^{( 2 )} ( i ) ) \\ Im ( {x}^{( 3 )} ( i ) )\end{matrix} ] . \qquad [ Eqn . 6 ]$$

for i=0,1, . . . , M_{symb}^{layer}−1 with M_{symb}^{ap}=4M_{symb}^{layer}.

After precoding 320, the resource elements are mapped by the resource element mapper(s) 325. For each of the antenna ports 340 used for transmission of the physical channel 300, the block of complex-valued symbols y^{(P)}(0), . . . , y^{(P)}(M_{symb}^{ap}−1) are mapped in sequence. The mapping sequence is started by mapping y^{(P)}(0) to resource elements (k, 1) in physical resource blocks corresponding to virtual resource blocks assigned for transmission and not used for transmission of Physical Control Format Indicator Channel (PCFICH), Physical Hybrid Automatic Repeat Request Indicator Channel (PHICH), primary broadcast channel (PBCH), synchronization signals or reference signals. The mapping to resource elements (k, 1) on antenna port (P) not reserved for other purposes shall be in increasing order of first the index k over the assigned physical resource blocks and then the index 1, starting with the first slot in a subframe.

FIG. 4 illustrates details of the layer mapper 315 and precoder 320 of FIG. 3 according to one embodiment of the present disclosure. The embodiment of the layer mapper 315 and precoder 320 shown in FIG. 4 is for illustration only. Other embodiments of the layer mapper 315 and precoder 320 could be used without departing from the scope of this disclosure.

In some embodiments, a two-layer transmit diversity (TxD) preceding scheme is the Alamouti scheme. In such embodiment, the precoder output is defined by Equation 7:

$$\begin{matrix}\begin{matrix}[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}Re ( {x}^{( 0 )} ( i ) ) + j Im ( {x}^{( 0 )} ( i ) ) \\ - Re ( {x}^{( 1 )} ( i ) ) + j Im ( {x}^{( 1 )} ( i ) ) \\ Re ( {x}^{( 1 )} ( i ) ) + j Im ( {x}^{( 1 )} ( i ) ) \\ Re ( {x}^{( 0 )} ( i ) ) - j Im ( {x}^{( 0 )} ( i ) )\end{matrix} ] \\ = \frac{1}{\sqrt{2}} [ \begin{matrix}{x}^{( 0 )} ( i ) \\ - {( {x}^{( 1 )} ( i ) )}^{*} \\ {x}^{( 1 )} ( i ) \\ {( {x}^{( 0 )} ( i ) )}^{*}\end{matrix} ] .\end{matrix} & [ Eqn . 7 ]\end{matrix}$$

In Equation 7, () denotes the complex conjugate and is equivalent to Equation 8:

$$[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 )\end{matrix} ] = \frac{1}{\sqrt{2}} [ \begin{matrix}{x}^{( 0 )} ( i ) & {x}^{( 1 )} ( i ) \\ - {( {x}^{( 1 )} ( i ) )}^{*} & {( {x}^{0} ( i ) )}^{*}\end{matrix} ] . \qquad [ Eqn . 8 ]$$

In Equation 8, the precoded signal matrix of the Alamouti scheme is denoted as X_{Alamouti} (i) as illustrated by Equation 9:

$$\begin{matrix}\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 )\end{matrix} ] = {X}_{Alamouti} ( i ) \\ ≡ \frac{1}{\sqrt{2}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*}\end{matrix} ] .\end{matrix} & [ Eqn . 9 ]\end{matrix}$$

The receiver algorithm for the Alamouti scheme can be efficiently designed by exploiting the orthogonal structure of the received signal. For example, for a receiver with one receive antenna, and denoting the channel gains between transmit (Tx) antenna (Tx layer) P and the receive antenna for i=0,1, . . . , M_{symb}^{layer}−1 by h^{(P)}(i), a matrix equation for the relation between the received signal and the transmitted signal is defined by Equations 10a and 10b:

$$\begin{matrix} r ( 2 i ) = \frac{1}{\sqrt{2}} [ \begin{matrix}{h}^{( 0 )} ( 2 i ) & {h}^{( 1 )} ( 2 i )\end{matrix} ] [ \begin{matrix}{x}^{( 0 )} ( i ) \\ - {( {x}^{( 1 )} ( i ) )}^{*}\end{matrix} ] + n ( 2 i ) . & [ Eqn . 10 a ] \\ r ( 2 i + 1 ) = \frac{1}{\sqrt{2}} [ \begin{matrix}{h}^{( 0 )} ( 2 i + 1 ) & {h}^{( 1 )} ( 2 i + 1 )\end{matrix} ] [ \begin{matrix}{x}^{( 1 )} ( i ) \\ {( {x}^{( 0 )} ( i ) )}^{*}\end{matrix} ] + n ( 2 i + 1 ) . & [ Eqn . 10 b ]\end{matrix}$$

In Equations 10a and 10b, r(2i) and r(2i+1) are the received signals and n(2i) and n(2i+1) are the received noises in the corresponding resource element. If h⁽⁰⁾(2i)=h⁽⁰⁾(2i+1) and h⁽¹⁾(2i)=h⁽¹⁾(2i+1), then Equations 10a and 10b can be rewritten as Equation 11, facilitating the detection of x⁽⁰⁾(i) and −(x⁽¹⁾(i))*:

$$[ \begin{matrix}r ( 2 i ) \\ {( r ( 2 i + 1 ) )}^{*}\end{matrix} ] = [ \begin{matrix}{h}^{( 0 )} ( 2 i ) & {h}^{( 1 )} ( 2 i ) \\ {( {h}^{( 1 )} ( 2 i ) )}^{*} & - {( {h}^{( 0 )} ( 2 i ) )}^{*}\end{matrix} ] [ \begin{matrix}{x}^{( 0 )} ( i ) \\ - {( {x}^{( 1 )} ( i ) )}^{*}\end{matrix} ] + [ \begin{matrix}{n}_{1} \\ {n}_{2}^{*}\end{matrix} ] . \qquad [ Eqn . 11 ]$$

In order to detect x⁽⁰⁾(i), [(h⁽⁰⁾(2i))*h⁽¹⁾(2i)] is multiplied to both sides of Equation 11. Since the columns of the matrix in Equation 11 are orthogonal to each other, the multiplication results in the component of x⁽⁰⁾(i) becoming zero (0) in the equation. Thus, an interference-free detection for x⁽⁰⁾(i) can be done. Additionally, [(h⁽¹⁾(2i)−h⁽⁰⁾(2i)] can be multiplied to both sides of Equation 11. Therefore, each symbol has been passed through two channel gains and the diversity is achieved for each pair of the symbols. Since the information stream is transmitted over antennas (space) and over different resource elements (either time or frequency), these schemes are referred to as Alamouti code space time-block code (STBC) or space frequency block code (SFBC).

In some embodiments, a four-layer transmit diversity (TxD) preceding scheme is the Golden code. Golden code is useful when the receiver is required to have two or more receive (Rx) antennas. Using Golden code, four complex symbols can be reliably transmitted to the receiver, spending two time resources (or two subcarriers). Given the vectors for the four-layer signals, the precoded signal matrix over Tx antennas (rows) and over subcarriers or symbol intervals (columns) of the Golden code is defined by Equation 12:

$$[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 )\end{matrix} ] = {X}_{GoldenCode} ( i ) ≡ [ \begin{matrix}( 1 + j \overline{g} ) ( {x}^{( 0 )} ( i ) + {gx}^{( 1 )} ( i ) ) & ( 1 + j \overline{g} ) ( {x}^{( 2 )} ( i ) + {gx}^{( 3 )} ( i ) ) \\ ( 1 + j g ) ( {x}^{( 2 )} ( i ) + \overline{g} {x}^{( 3 )} ( i ) ) & ( 1 + j g ) ( {x}^{( 0 )} ( i ) + \overline{g} {x}^{( 1 )} ( i ) )\end{matrix} ] . \qquad [ Eqn . 12 ]$$

In Equation 12, j=\sqrt{−1}, g is the Golden number

$$( i . e . , g = \frac{1 + \sqrt{5}}{2} and \overline{g} = 1 - g = \frac{1 - \sqrt{5}}{2} ) .$$

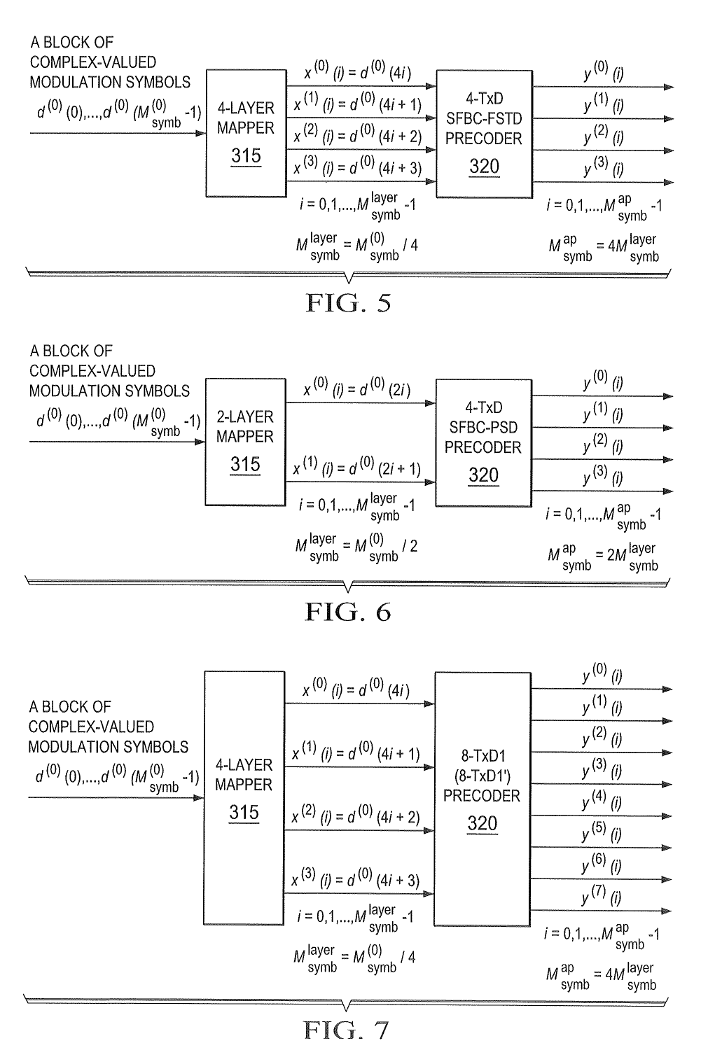

FIG. 5 illustrates details of another layer mapper 315 and precoder 320 of FIG. 3 according to one embodiment of the present disclosure. The embodiment of the layer mapper 315 and precoder 320 shown in FIG. 5 is for illustration only. Other embodiments of the layer mapper 315 and precoder 320 could be used without departing from the scope of this disclosure.

When 4-Tx antennas are available at the transmitter, the TxD schemes can include SFBC-FSTD (FSTD: frequency switch transmit diversity), SFBC-PSD (PSD: phase-shift diversity), quasi-orthogonal SFBC (QO-SFBC), SFBC-CDD (CDD: cyclic delay diversity) and balanced SFBC/FSTD. SFBC-FSTD refers to a TxD scheme utilizing Alamouti SFBC over 4-Tx antennas and 4 subcarriers in a block diagonal fashion. The relevant blocks in the block diagram showing the physical channel processing in LTE are drawn in detail in FIG. 5 for the four-layer TxD in LTE.

In one embodiment, the precoder 320 is a 4-layer TxD (or 4-TxD) SFBC-SFTD precoder. The precoded signal matrix over Tx antennas (rows) and over subcarriers (columns) for the SFBC-FSTD is defined by Equation 13:

$$[ \begin{matrix}{y}^{( 0 )} ( 4 i ) & {y}^{( 0 )} ( 4 i + 1 ) & {y}^{( 0 )} ( 4 i + 2 ) & {y}^{( 0 )} ( 4 i + 3 ) \\ {y}^{( 1 )} ( 4 i ) & {y}^{( 1 )} ( 4 i + 1 ) & {y}^{( 1 )} ( 4 i + 2 ) & {y}^{( 1 )} ( 4 i + 3 ) \\ {y}^{( 2 )} ( 4 i ) & {y}^{( 2 )} ( 4 i + 1 ) & {y}^{( 2 )} ( 4 i + 2 ) & {y}^{( 2 )} ( 4 i + 3 ) \\ {y}^{( 3 )} ( 4 i ) & {y}^{( 3 )} ( 4 i + 1 ) & {y}^{( 3 )} ( 4 i + 2 ) & {y}^{( 3 )} ( 4 i + 3 )\end{matrix} ] = {X}_{S F B C \text{-} F S T D} ( i ) ≡ \frac{1}{\sqrt{2}} [ \begin{matrix}{x}^{( 0 )} ( i ) & {x}^{( 1 )} ( i ) & 0 & 0 \\ 0 & 0 & {x}^{( 2 )} ( i ) & {x}^{( 3 )} ( i ) \\ - {( {x}^{( 1 )} ( i ) )}^{*} & {( {x}^{( 0 )} ( i ) )}^{*} & 0 & 0 \\ 0 & 0 & - {( {x}^{( 3 )} ( i ) )}^{*} & {( {x}^{( 2 )} ( i ) )}^{*}\end{matrix} ] . \qquad [ Eqn . 13 ]$$

In another embodiment, an SFBC-PSD scheme is utilized. In such embodiment, the precoder 320 is an SFBC-PSD precoder. The precoded signal matrix over 4-Tx antennas and two subcarriers is defined by Equation 14:

$$\begin{matrix}\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D} ( i ) \\ ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} {k}_{2 i}} & - {( {x}^{( 1 )} ( i ) )}^{*} {e}^{j {θ}_{1} {k}_{2 i}} \\ {x}^{( 1 )} ( i ) {e}^{j {θ}_{2} {k}_{2 i}} & {( {x}^{( 0 )} ( i ) )}^{*} {e}^{j {θ}_{2} {k}_{2 i}}\end{matrix} ] ,\end{matrix} & [ Eqn . 14 ]\end{matrix}$$

In Equation 14, k₂ᵢ is an associated subcarrier index for the resource element corresponding to index 2i and θ₁ and θ₂ are constants that can be optimized.

In yet another embodiment, the precoded signal matrix of the QO-SFBC (over 4-Tx antennas and over four (4) subcarriers) is defined by Equation 15:

$$[ \begin{matrix}{y}^{( 0 )} ( 4 i ) & {y}^{( 0 )} ( 4 i + 1 ) & {y}^{( 0 )} ( 4 i + 2 ) & {y}^{( 0 )} ( 4 i + 3 ) \\ {y}^{( 1 )} ( 4 i ) & {y}^{( 1 )} ( 4 i + 1 ) & {y}^{( 1 )} ( 4 i + 2 ) & {y}^{( 1 )} ( 4 i + 3 ) \\ {y}^{( 2 )} ( 4 i ) & {y}^{( 2 )} ( 4 i + 1 ) & {y}^{( 2 )} ( 4 i + 2 ) & {y}^{( 2 )} ( 4 i + 3 ) \\ {y}^{( 3 )} ( 4 i ) & {y}^{( 3 )} ( 4 i + 1 ) & {y}^{( 3 )} ( 4 i + 2 ) & {y}^{( 3 )} ( 4 i + 3 )\end{matrix} ] = {X}_{Q O \text{-} S F B C} ( i ) ≡ \frac{1}{\sqrt{4}} [ \begin{matrix}{x}^{( 0 )} ( i ) & - {( {x}^{( 1 )} ( i ) )}^{*} & {cx}^{( 2 )} ( i ) & - {( {x}^{( 3 )} ( i ) )}^{*} \\ {x}^{( 1 )} ( i ) & {( {x}^{( 0 )} ( i ) )}^{*} & {x}^{( 3 )} ( i ) & {{c}^{*} ( {x}^{( 2 )} ( i ) )}^{*} \\ {x}^{( 2 )} ( i ) & - {( {x}^{( 3 )} ( i ) )}^{*} & {x}^{( 0 )} ( i ) & - {{c}^{*} ( {x}^{( 1 )} ( i ) )}^{*} \\ {x}^{( 3 )} ( i ) & {( {x}^{( 2 )} ( i ) )}^{*} & {cx}^{( 1 )} ( i ) & {( {x}^{( 0 )} ( i ) )}^{*}\end{matrix} ] , \qquad [ Eqn . 15 ]$$

In Equation 15, c is a constant that can be optimized.

In still another embodiment, the precoded signal matrix of SFBC-CDD (over 4-Tx antennas and over two subcarriers) is defined by Equation 16:

$$[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} C D D} ( i ) ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} {k}_{2 i}} & - {( {x}^{( 1 )} ( i ) )}^{*} {e}^{j {θ}_{1} {k}_{2 i + 1}} \\ {x}^{( 1 )} ( i ) {e}^{{jθ}_{2} {k}_{2 i}} & {( {x}^{( 0 )} ( i ) )}^{*} {e}^{{jθ}_{2} {k}_{2 i + 1}}\end{matrix} ] , \qquad [ Eqn . 16 ]$$

In Equation 16, k₂ᵢ and k₂ᵢ₊₁ is an associated subcarrier index for the resource element corresponding to index 2i and 2i+1, and θ₁ and θ₂ are constants that can be optimized.

In still another embodiment, the precoded signal matrix of SFBC-FSTD (over 4-Tx antennas and over four subcarriers) is defined by Equation 17:

$$[ \begin{matrix}{y}^{( 0 )} ( 4 i ) & {y}^{( 0 )} ( 4 i + 1 ) & {y}^{( 0 )} ( 4 i + 2 ) & {y}^{( 0 )} ( 4 i + 3 ) \\ {y}^{( 1 )} ( 4 i ) & {y}^{( 1 )} ( 4 i + 1 ) & {y}^{( 1 )} ( 4 i + 2 ) & {y}^{( 1 )} ( 4 i + 3 ) \\ {y}^{( 2 )} ( 4 i ) & {y}^{( 2 )} ( 4 i + 1 ) & {y}^{( 2 )} ( 4 i + 2 ) & {y}^{( 2 )} ( 4 i + 3 ) \\ {y}^{( 3 )} ( 4 i ) & {y}^{( 3 )} ( 4 i + 1 ) & {y}^{( 3 )} ( 4 i + 2 ) & {y}^{( 3 )} ( 4 i + 3 )\end{matrix} ] = {X}_{S F B C \text{-} F S T D} ( i ) = \frac{1}{\sqrt{4}} [ \begin{matrix}{x}^{( 0 )} ( i ) & - {( {x}^{( 1 )} ( i ) )}^{*} & {x}^{( 0 )} ( i ) & - {( {x}^{( 1 )} ( i ) )}^{*} \\ {x}^{( 1 )} ( i ) & {( {x}^{( 0 )} ( i ) )}^{*} & {x}^{( 1 )} ( i ) & {( {x}^{( 0 )} ( i ) )}^{*} \\ - {x}^{( 2 )} ( i ) & {( {x}^{( 3 )} ( i ) )}^{*} & {x}^{( 2 )} ( i ) & - {( {x}^{( 3 )} ( i ) )}^{*} \\ - {x}^{( 3 )} ( i ) & - {( {x}^{( 2 )} ( i ) )}^{*} & {x}^{( 3 )} ( i ) & {( {x}^{( 2 )} ( i ) )}^{*}\end{matrix} ] . \qquad [ Eqn . 17 ]$$

FIG. 6 illustrates details of yet another layer mapper 315 and precoder 320 of FIG. 3 according to one embodiment of the present disclosure. The embodiment of the layer mapper 315 and precoder 320 shown in FIG. 6 is for illustration only. Other embodiments of the layer mapper 315 and precoder 320 could be used without departing from the scope of this disclosure.

In some embodiments, a modified 4-TxD SFBC-PSD scheme (denoted as 4-TxD SFBC-PSD2) is utilized. In such embodiments, precoder 320 is a 4-TxD SFBC-PSD precoder. Further, the precoder 320 output is defined by Equation 18:

$$[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 2} ( i ) ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} k} & - {( {x}^{( 1 )} ( i ) )}^{*} {e}^{j {θ}_{1} k} \\ {x}^{( 1 )} ( i ) {e}^{j ( {θ}_{2} k + φ )} & {( {x}^{( 0 )} ( i ) )}^{*} {e}^{j ( {θ}_{2} k + φ )}\end{matrix} ] , \qquad [ Eqn . 18 ]$$

In Equation 18, i=0,1, . . . , M_{symb}^{ap}−1, M_{symb}^{ap}=2M_{symb}^{layer}, θ₁, θ₂ and φ are a set of real parameters (for example, φ=π), k is a physical subcarrier index associated with data subcarrier index 2i and 2i+1. Further, the parameter φ accounts for degradation in correlated signals. Each column is transmitted over Tx antennas, while each row is transmitted over subcarriers. As such, Equation 18 can be rewritten as Equation 19:

$$[ \begin{matrix}{y}^{( 0 )} ( 2 i ) \\ {y}^{( 1 )} ( 2 i ) \\ {y}^{( 2 )} ( 2 i ) \\ {y}^{( 3 )} ( 2 i ) \\ {y}^{( 0 )} ( 2 i + 1 ) \\ {y}^{( 1 )} ( 2 i + 1 ) \\ {y}^{( 2 )} ( 2 i + 1 ) \\ {y}^{( 3 )} ( 2 i + 1 )\end{matrix} ] = \frac{1}{\sqrt{4}} [ \begin{matrix}1 & 0 & j & 0 \\ 0 & 1 & 0 & j \\ {e}^{j {θ}_{1} k} & 0 & j {e}^{j {θ}_{1} k} & 0 \\ 0 & {e}^{j ( {θ}_{2} k + φ )} & 0 & j {e}^{j ( {θ}_{2} k + φ )} \\ - 1 & 0 & j & 0 \\ 0 & 1 & 0 & - j \\ - {e}^{j {θ}_{1} k} & 0 & j {e}^{j {θ}_{1} k} & 0 \\ 0 & {e}^{j ( {θ}_{2} k + φ )} & 0 & - j {e}^{j ( {θ}_{2} k + φ )}\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] \qquad [ Eqn . 19 ]$$

In such embodiments, an efficient receiver for SFBC-PSD2 can be utilized. The receiver is configured to exploit the orthogonal structure of the received signal. In embodiments with one Rx antenna at the receiver, denoting the channel matrix at subcarrier k by H(k)=[h⁽¹⁾(k) h⁽²⁾(k) h⁽³⁾(k) h⁽⁴⁾(k)] and denoting the additive noise by n(k), the received signals r(k₂ᵢ) and r(k₂ᵢ₊₁) are defined by Equations 20 and 21:

$$\begin{matrix}r ( {k}_{2 i} ) = [ \begin{matrix}{h}^{( 1 )} ( {k}_{2 i} ) & {h}^{( 2 )} ( {k}_{2 i} ) & {h}^{( 3 )} ( {k}_{2 i} ) & {h}^{( 4 )} ( {k}_{2 i} )\end{matrix} ] [ \begin{matrix}{x}^{( 0 )} ( i ) \\ {x}^{( 1 )} ( i ) \\ {x}^{( 0 )} ( i ) {e}^{j k {θ}_{1}} \\ {x}^{( 1 )} ( i ) {e}^{j ( k {θ}_{2} + φ )}\end{matrix} ] + n ( {k}_{2 i} ) , & [ Eqn . 20 ] \\ r ( {k}_{2 i + 1} ) = [ \begin{matrix}{h}^{( 1 )} ( {k}_{2 i + 1} ) & {h}^{( 2 )} ( {k}_{2 i + 1} ) & {h}^{( 3 )} ( {k}_{2 i + 1} ) & {h}^{( 4 )} ( {k}_{2 i + 1} )\end{matrix} ] [ \begin{matrix}- {( {x}^{( 1 )} ( i ) )}^{*} \\ {( {x}^{( 0 )} ( i ) )}^{*} \\ - {( {x}^{( 1 )} ( i ) )}^{*} {e}^{j k {θ}_{1}} \\ {( {x}^{( 0 )} ( i ) )}^{*} {e}^{j ( k {θ}_{2} + φ )}\end{matrix} ] & [ Eqn . 21 ]\end{matrix}$$

In Equations 20 and 21, k₂ᵢ and k₂ᵢ₊₁ are physical subcarrier indices associated with data subcarrier indices 2i and 2i+1 respectively.

Equations 20 and 21 are equivalent to matrix Equation 22:

$$[ \begin{matrix}r ( {k}_{2 i} ) \\ {r}^{*} ( {k}_{2 i + 1} )\end{matrix} ] = [ \begin{matrix}{h}^{( 1 )} ( {k}_{2 i} ) + {e}^{j k {θ}_{1}} {h}^{( 3 )} ( {k}_{2 i} ) & {h}^{( 2 )} ( {k}_{2 i} ) + {e}^{j ( k {θ}_{2} + φ )} {h}^{( 4 )} ( {k}_{2 i} ) \\ \begin{matrix}{( {h}^{( 2 )} ( {k}_{2 i + 1} ) )}^{*} + \\ {{e}^{- j ( k {θ}_{2} + φ )} ( {h}^{( 4 )} ( {k}_{2 i + 1} ) )}^{*}\end{matrix} & - {( {h}^{( 1 )} ( {k}_{2 i + 1} ) )}^{*} - {{e}^{- j k {θ}_{1}} ( {h}^{( 3 )} ( {k}_{2 i + 1} ) )}^{*}\end{matrix} ] [ \begin{matrix}{x}^{( 0 )} ( i ) \\ {x}^{( 1 )} ( i )\end{matrix} ] + [ \begin{matrix}n ( {k}_{2 i} ) \\ {n}^{*} ( {k}_{2 i + 1} )\end{matrix} ] \qquad [ Eqn . 22 ]$$

When [h⁽¹⁾(k₂ᵢ) h⁽²⁾(k₂ᵢ) h⁽³⁾(k₂ᵢ) h⁽⁴⁾(k₂ᵢ)]=[h⁽¹⁾(k₂ᵢ₊₁) h⁽²⁾(k₂ᵢ₊₁) h⁽³⁾(k₂ᵢ₊₁) h⁽⁴⁾(k₂ᵢ₊₁)], the two columns in matrix Equation 22 are orthogonal. In order to recover x⁽⁰⁾(i) and x⁽¹⁾(i), the conjugate transpose of the column is left-multiplied to Equation 22. An example is illustrated by Equation 23:

$${\tilde{H}}_{1} ( i ) [ \begin{matrix}r ( {k}_{2 i} ) \\ {r}^{*} ( {k}_{2 i + 1} )\end{matrix} ] = ( \begin{matrix}{\vert {h}^{( 1 )} ( {k}_{2 i} ) + {e}^{j k {θ}_{1}} {h}^{( 3 )} ( {k}_{2 i} ) \vert}^{2} + \\ {\vert {h}^{( 2 )} ( {k}_{2 i} ) + {e}^{j ( k {θ}_{2} + φ )} {h}^{( 4 )} ( {k}_{2 i} ) \vert}^{2}\end{matrix} ) {s}_{1} + {\tilde{H}}_{1} [ \begin{matrix}n ( 1 ) \\ {n}^{*} ( 2 )\end{matrix} ] \qquad [ Eqn . 23 ]$$

In Equation 23, \tilde{H}₁(i)=[h⁽¹⁾(k₂ᵢ)+e^{jkθ}^{₁}h⁽³⁾(k₂ᵢ) h⁽²⁾(k₂ᵢ)+e^{j(kθ}^{₂}^{+φ)}h⁽⁴⁾(k₂ᵢ)]*, which is the complex conjugate transpose of the first column. After the left-multiply operation, a conventional single-symbol demodulation method (e.g., a maximum-a-priori (MAP) detection) is utilized to detect x⁽⁰⁾(i), or to obtain the log-likelihood-ration values associated to x⁽⁰⁾(i). In embodiments with multiple Rx antennas at the receiver, coherent combing (or maximum-ratio-combining (MRC)) is utilized.

In another embodiment, a second modified 4-TxD SFBC-PSD (denoted as 4-TxD SFBC-PSD3) scheme is utilized. In such embodiments, precoder 320 is a 4-TxD SFBC-PSD precoder. Further, the precoder 320 output is defined by the precoded signal matrix of a 4-TxD SFBC-PSD3 and defined by Equation 24.

$$[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 3} ( i ) ≡ \frac{1}{\sqrt{4}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] , \qquad [ Eqn . 24 ]$$

In Equation 24, i=0,1, . . . , M_{symb}^{ap}=−1, M_{symb}^{ap}=2M_{symb}^{layer}, angles θ₁, θ₂ and φ are a set of parameters, k is a physical subcarrier index associated with data subcarrier index 2i and 2i+1. Further, an efficient decoder for this scheme, similar to the one for X_{SFBC-PSD2}(i), may be utilized. The precoded signal matrix defined by Equation 24 can be alternatively written in a form like Equation 19.

In another embodiment, the rows of the matrix on the right-hand-side in each of Equations 18 and 24 are permuted to obtain additional precoded signal matrices. For example, switching the second and the third rows of the matrix in Equation 18 yields another precoded signal matrix (denoted by SFBC-PSD4) illustrated by Equation 25:

$$[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 4} ( i ) ≡ \frac{1}{\sqrt{4}} [ \begin{matrix}{x}^{( 0 )} ( i ) & {x}^{( 1 )} ( i ) \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} & {( {x}^{( 0 )} ( i ) )}^{*} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] . \qquad [ Eqn . 25 ]$$

Equation 25 can be rewritten as Equation 26:

$$[ \begin{matrix}{y}^{( 0 )} ( 2 i ) \\ {y}^{( 1 )} ( 2 i ) \\ {y}^{( 2 )} ( 2 i ) \\ {y}^{( 3 )} ( 2 i ) \\ {y}^{( 0 )} ( 2 i + 1 ) \\ {y}^{( 1 )} ( 2 i + 1 ) \\ {y}^{( 2 )} ( 2 i + 1 ) \\ {y}^{( 3 )} ( 2 i + 1 )\end{matrix} ] = \frac{1}{\sqrt{4}} [ \begin{matrix}1 & 0 & j & 0 \\ {e}^{j {θ}_{1} k} & 0 & j {e}^{j {θ}_{1} k} & 0 \\ 0 & - 1 & 0 & j \\ 0 & - {e}^{j ( {θ}_{2} k + φ )} & 0 & - j {e}^{j ( {θ}_{2} k + φ )} \\ - 1 & 0 & j & 0 \\ - {e}^{j {θ}_{1} k} & 0 & j {e}^{j {θ}_{1} k} & 0 \\ 0 & 1 & 0 & - j \\ 0 & {e}^{j ( {θ}_{2} k + φ )} & 0 & - j {e}^{j ( {θ}_{2} k + φ )}\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] \qquad [ Eqn . 26 ]$$

In some embodiments, up to four 4-TxD schemes having the same dimension for their signal matrices are utilized to construct an 8-TxD precoded signal matrix. The 8-TxD precoded signal matrix is constructed by constructing a block matrix with the four 4-TxD schemes over Tx antennas and subcarriers. For example, when X₁, X₂, X₃ and X₄ are four 4-TxD precoded signal matrices, then the 8-TxD precoded signal matrix is defined by Equation 27:

$${X}_{8 T \times D} = [ \begin{matrix}{X}_{1} & {X}_{2} \\ {X}_{3} & {X}_{4}\end{matrix} ] \qquad [ Eqn . 27 ]$$

In Equation 27, each column of X_{8TxD} is transmitted over 8-Tx antennas, while each row is transmitted over either time resources or subcarriers of the OFDM system. The precoded signal matrix defined by Equation 27 can be alternatively written in a form like Equation 19.

Further, in some embodiments, one or more of the matrices, X₁, X₂, X₃ and X₄, in X_{8TxD} are zero matrices. The rows of the precoded signal matrix X_{8TxD} are permuted to construct another 8-TxD precoded matrix.

For the 8-TxD precoder operation, the layer mapping 315 for the 6-layer and 8-layer cases are performed according to Table 2.

TABLE 2
Codeword-to-layer mapping for transmit diversity

| Number of | Number of | Codeword-to-layer mapping |
|---|---|---|
| layers | code words | i = 0, 1, . . . , M_{symb}^{layer} − 1 |
| 6 | 1 | x⁽⁰⁾ (i) = d⁽⁰⁾ (6i) M_{symb}^{layer} = M_{symb}⁽⁰⁾/6 |
| | | x⁽¹⁾ (i) = d⁽⁰⁾ (6i + 1) |
| | | x⁽²⁾ (i) = d⁽⁰⁾ (6i + 2) |
| | | x⁽³⁾ (i) = d⁽⁰⁾ (6i + 3) |
| | | x⁽⁴⁾ (i) = d⁽⁰⁾ (6i + 4) |
| | | x⁽⁵⁾ (i) = d⁽⁰⁾ (6i + 5) |
| 8 | 1 | x⁽⁰⁾ (i) = d⁽⁰⁾ (8i) M_{symb}^{layer} = M_{symb}⁽⁰⁾/8 |
| | | x⁽¹⁾ (i) = d⁽⁰⁾ (8i + 1) |
| | | x⁽²⁾ (i) = d⁽⁰⁾ (8i + 2) |
| | | x⁽³⁾ (i) = d⁽⁰⁾ (8i + 3) |
| | | x⁽⁴⁾ (i) = d⁽⁰⁾ (8i + 4) |
| | | x⁽⁵⁾ (i) = d⁽⁰⁾ (8i + 5) |
| | | x⁽⁶⁾ (i) = d⁽⁰⁾ (8i + 6) |
| | | x⁽⁷⁾ (i) = d⁽⁰⁾ (8i + 7) |

FIG. 7 illustrates details of yet another layer mapper 315 and precoder 320 of FIG. 3 according to one embodiment of the present disclosure. The embodiment of the layer mapper 315 and precoder 320 shown in FIG. 7 is for illustration only. Other embodiments of the layer mapper 315 and precoder 320 could be used without departing from the scope of this disclosure.

In such embodiments, the layer mapper 315 is a 4-layer mapper and the precoder 320 is a 8-TxD1 precoder. Further, X₂ and X₃ are zero matrices and ν=4 signal layers are constructed for the 8-TxD preceding. Then, a block diagonal precoded signal matrix is obtained as defined by Equation 28:

$${X}_{8 T \times D 1} = [ \begin{matrix}{X}_{1} & {0}_{4 \times 2} \\ {0}_{4 \times 2} & {X}_{4}\end{matrix} ] \qquad [ Eqn . 28 ]$$

In Equation 28, 0_{4×4} is a 4×4 zero matrix. SFBC-PSD3 is used to construct both X₁ and X₄. Then, the codeword-to-layer mapping and precoding operation is illustrated in FIG. 7 and the precoded signal matrix (denoted by X_{8TxD1}) is defined by Equation 29:

$$[ \begin{matrix}{y}^{( 0 )} ( 4 i ) & {y}^{( 0 )} ( 4 i + 1 ) & {y}^{( 0 )} ( 4 i + 2 ) & {y}^{( 0 )} ( 4 i + 3 ) \\ {y}^{( 1 )} ( 4 i ) & {y}^{( 1 )} ( 4 i + 1 ) & {y}^{( 1 )} ( 4 i + 2 ) & {y}^{( 1 )} ( 4 i + 3 ) \\ {y}^{( 2 )} ( 4 i ) & {y}^{( 2 )} ( 4 i + 1 ) & {y}^{( 2 )} ( 4 i + 2 ) & {y}^{( 2 )} ( 4 i + 3 ) \\ {y}^{( 3 )} ( 4 i ) & {y}^{( 3 )} ( 4 i + 1 ) & {y}^{( 3 )} ( 4 i + 2 ) & {y}^{( 3 )} ( 4 i + 3 ) \\ {y}^{( 4 )} ( 4 i ) & {y}^{( 4 )} ( 4 i + 1 ) & {y}^{( 4 )} ( 4 i + 2 ) & {y}^{( 4 )} ( 4 i + 3 ) \\ {y}^{( 5 )} ( 4 i ) & {y}^{( 5 )} ( 4 i + 1 ) & {y}^{( 5 )} ( 4 i + 2 ) & {y}^{( 5 )} ( 4 i + 3 ) \\ {y}^{( 6 )} ( 4 i ) & {y}^{( 6 )} ( 4 i + 1 ) & {y}^{( 6 )} ( 4 i + 2 ) & {y}^{( 6 )} ( 4 i + 3 ) \\ {y}^{( 7 )} ( 4 i ) & {y}^{( 7 )} ( 4 i + 1 ) & {y}^{( 7 )} ( 4 i + 2 ) & {y}^{( 7 )} ( 4 i + 3 )\end{matrix} ] = {X}_{8 T \times D 1} ( i ) ≡ [ \begin{matrix}{x}^{( 0 )} ( i ) & & {x}^{( 1 )} ( i ) & & & \\ - {( {x}^{( 1 )} ( i ) )}^{*} & & {( {x}^{( 0 )} ( i ) )}^{*} & & 0 & \\ {x}^{( 0 )} ( i ) {e}^{j {θ}_{1} {k}_{4 i}} & & - {x}^{( 1 )} ( i ) {e}^{j {θ}_{1} {k}_{4 i}} & & & \\ - {( {x}^{( 1 )} ( i ) )}^{*} {e}^{j ( {θ}_{2} {k}_{4 i} + φ )} & & {( {x}^{( 0 )} ( i ) )}^{*} {e}^{j ( {θ}_{2} {k}_{4 i} + φ )} & & & \\ & & & {x}^{( 2 )} ( i ) & & {x}^{( 3 )} ( i ) \\ & 0 & & - {( {x}^{( 3 )} ( i ) )}^{*} & & {( {x}^{( 2 )} ( i ) )}^{*} \\ & & & {x}^{( 2 )} ( i ) {e}^{j {θ}_{1} {k}_{4 i + 2}} & & - {x}^{( 3 )} ( i ) {e}^{j {θ}_{1} {k}_{4 i + 2}} \\ & & & - {( {x}^{( 3 )} ( i ) )}^{*} {e}^{j ( {θ}_{2} {k}_{4 i + 2} + φ )} & & {( {x}^{( 2 )} ( i ) )}^{*} {e}^{j ( {θ}_{2} {k}_{4 i + 2} + φ )}\end{matrix} ] , \qquad [ Eqn . 29 ]$$

In Equation 29, i=0,1, . . . , M_{symb}^{ap}−1, M_{symb}^{ap}=4M_{symb}^{layer}, k₄ᵢ is a physical subcarrier index associated with data subcarrier index 4i and 4i+1, and k₄ᵢ₊₂ is associated with 4i+2 and 4i+3.

In another embodiment, the layer mapper 315 is a 4-layer mapper and the precoder 320 is a 8-TxD1′ precoder. Further, the rows of precoded signal matrix X_{8TxD1} are permuted to obtain another precoded signal matrix X′_{8TxD1}. In one illustrative example, the rows are permuted as (1→1), (2→5), (3→2), (4→7), (5→2), (6→6), (7→4),(8→8), where the notation (p→q) implies that row p in the old matrix is located at low q in the new matrix. Then, the codeword-to-layer mapping and preceding operation is illustrated in FIG. 7 and the precoded signal matrix (denoted by X′_{8TxD1}) is defined by Equation 30:

$$[ \begin{matrix}{y}^{( 0 )} ( 4 i ) & {y}^{( 0 )} ( 4 i + 1 ) & {y}^{( 0 )} ( 4 i + 2 ) & {y}^{( 0 )} ( 4 i + 3 ) \\ {y}^{( 1 )} ( 4 i ) & {y}^{( 1 )} ( 4 i + 1 ) & {y}^{( 1 )} ( 4 i + 2 ) & {y}^{( 1 )} ( 4 i + 3 ) \\ {y}^{( 2 )} ( 4 i ) & {y}^{( 2 )} ( 4 i + 1 ) & {y}^{( 2 )} ( 4 i + 2 ) & {y}^{( 2 )} ( 4 i + 3 ) \\ {y}^{( 3 )} ( 4 i ) & {y}^{( 3 )} ( 4 i + 1 ) & {y}^{( 3 )} ( 4 i + 2 ) & {y}^{( 3 )} ( 4 i + 3 ) \\ {y}^{( 4 )} ( 4 i ) & {y}^{( 4 )} ( 4 i + 1 ) & {y}^{( 4 )} ( 4 i + 2 ) & {y}^{( 4 )} ( 4 i + 3 ) \\ {y}^{( 5 )} ( 4 i ) & {y}^{( 5 )} ( 4 i + 1 ) & {y}^{( 5 )} ( 4 i + 2 ) & {y}^{( 5 )} ( 4 i + 3 ) \\ {y}^{( 6 )} ( 4 i ) & {y}^{( 6 )} ( 4 i + 1 ) & {y}^{( 6 )} ( 4 i + 2 ) & {y}^{( 6 )} ( 4 i + 3 ) \\ {y}^{( 7 )} ( 4 i ) & {y}^{( 7 )} ( 4 i + 1 ) & {y}^{( 7 )} ( 4 i + 2 ) & {y}^{( 7 )} ( 4 i + 3 )\end{matrix} ] = {X}_{8 T \times D 1}^{′} ( i ) ≡ \\ [ \begin{matrix}{x}^{( 0 )} ( i ) & {x}^{( 1 )} ( i ) & 0 & 0 \\ 0 & 0 & {x}^{( 2 )} ( i ) & {x}^{( 3 )} ( i ) \\ - {( {x}^{( 1 )} ( i ) )}^{*} & {( {x}^{( 0 )} ( i ) )}^{*} & 0 & 0 \\ 0 & 0 & - {( {x}^{( 3 )} ( i ) )}^{*} & {( {x}^{( 2 )} ( i ) )}^{*} \\ {x}^{( 0 )} ( i ) {e}^{j {θ}_{1} {k}_{4 i}} & - {x}^{( 1 )} ( i ) {e}^{j {θ}_{1} {k}_{4 i}} & 0 & 0 \\ 0 & 0 & {x}^{( 2 )} ( i ) {e}^{j {θ}_{1} {k}_{4 i + 2}} & - {x}^{( 3 )} ( i ) {e}^{j {θ}_{1} {k}_{4 i + 2}} \\ - {( {x}^{( 1 )} ( i ) )}^{*} {e}^{j ( {θ}_{2} {k}_{4 i} + φ )} & {( {x}^{( 0 )} ( i ) )}^{*} {e}^{j ( {θ}_{2} {k}_{4 i} + φ )} & 0 & 0 \\ 0 & 0 & - {( {x}^{( 3 )} ( i ) )}^{*} {e}^{j ( {θ}_{2} {k}_{4 i + 2} + φ )} & {( {x}^{( 2 )} ( i ) )}^{*} {e}^{j ( {θ}_{2} {k}_{4 i + 2} + φ )}\end{matrix} ] . \qquad [ Eqn . 30 ]$$

In Equation 30, i=0,1, . . . , M_{symb}^{ap}−1, M_{symb}^{ap}=4M_{symb}^{layer}, k₄ᵢ is a physical subcarrier index associated with data subcarrier index 4i and 4i+1, and k₄ᵢ₊₂ is associated with 4i+2 and 4i+3.

Equation 30 can be rewritten as Equations 31 and 32:

$$\begin{matrix}[ \begin{matrix}{y}^{( 0 )} ( 4 i ) \\ {y}^{( 1 )} ( 4 i ) \\ {y}^{( 2 )} ( 4 i ) \\ {y}^{( 3 )} ( 4 i ) \\ {y}^{( 4 )} ( 4 i ) \\ {y}^{( 5 )} ( 4 i ) \\ {y}^{( 6 )} ( 4 i ) \\ {y}^{( 7 )} ( 4 i ) \\ {y}^{( 0 )} ( 4 i + 1 ) \\ {y}^{( 1 )} ( 4 i + 1 ) \\ {y}^{( 2 )} ( 4 i + 1 ) \\ {y}^{( 3 )} ( 4 i + 1 ) \\ {y}^{( 4 )} ( 4 i + 1 ) \\ {y}^{( 5 )} ( 4 i + 1 ) \\ {y}^{( 6 )} ( 4 i + 1 ) \\ {y}^{( 7 )} ( 4 i + 1 )\end{matrix} ] = \frac{1}{\sqrt{4}} [ \begin{matrix}1 & 0 & 0 & 0 & 1 & 0 & 0 & 0 \\ 0 & 0 & 0 & 0 & 0 & 0 & 0 & 0 \\ 0 & - 1 & 0 & 0 & 0 & 1 & 0 & 0 \\ 0 & 0 & 0 & 0 & 0 & 0 & 0 & 0 \\ {e}^{{jθ}_{1} {k}_{4 i}} & 0 & 0 & 0 & {e}^{{jθ}_{1} {k}_{4 i}} & 0 & 0 & 0 \\ 0 & 0 & 0 & 0 & 0 & 0 & 0 & 0 \\ 0 & - {e}^{j ( {θ}_{2} {k}_{4 i} + φ )} & 0 & 0 & 0 & {e}^{j ( {θ}_{2} {k}_{4 i} + φ )} & 0 & 0 \\ 0 & 0 & 0 & 0 & 0 & 0 & 0 & 0 \\ 0 & 1 & 0 & 0 & 0 & 1 & 0 & 0 \\ 0 & 0 & 0 & 0 & 0 & 0 & 0 & 0 \\ 1 & 0 & 0 & 0 & - 1 & 0 & 0 & 0 \\ 0 & 0 & 0 & 0 & 0 & 0 & 0 & 0 \\ 0 & - {e}^{{jθ}_{1} {k}_{4 i}} & 0 & 0 & 0 & - {e}^{{jθ}_{1} {k}_{4 i}} & 0 & 0 \\ 0 & 0 & 0 & 0 & 0 & 0 & 0 & 0 \\ {e}^{j ( {θ}_{2} {k}_{4 i} + φ )} & 0 & 0 & 0 & - {e}^{j ( {θ}_{2} {k}_{4 i} + φ )} & 0 & 0 & 0 \\ 0 & 0 & 0 & 0 & 0 & 0 & 0 & 0\end{matrix} ] [ \begin{matrix}Re ( {x}^{( 0 )} ( i ) ) \\ Re ( {x}^{( 1 )} ( i ) ) \\ Re ( {x}^{( 2 )} ( i ) ) \\ Re ( {x}^{( 3 )} ( i ) ) \\ Im ( {x}^{( 0 )} ( i ) ) \\ Im ( {x}^{( 1 )} ( i ) ) \\ Im ( {x}^{( 2 )} ( i ) ) \\ Im ( {x}^{( 3 )} ( i ) )\end{matrix} ] . \\ and & [ Eqn . 31 ] \\ [ \begin{matrix}{y}^{( 0 )} ( 4 i + 2 ) \\ {y}^{( 1 )} ( 4 i + 2 ) \\ {y}^{( 2 )} ( 4 i + 2 ) \\ {y}^{( 3 )} ( 4 i + 2 ) \\ {y}^{( 4 )} ( 4 i + 2 ) \\ {y}^{( 5 )} ( 4 i + 2 ) \\ {y}^{( 6 )} ( 4 i + 2 ) \\ {y}^{( 7 )} ( 4 i + 3 ) \\ {y}^{( 0 )} ( 4 i + 3 ) \\ {y}^{( 1 )} ( 4 i + 3 ) \\ {y}^{( 2 )} ( 4 i + 3 ) \\ {y}^{( 3 )} ( 4 i + 3 ) \\ {y}^{( 4 )} ( 4 i + 3 ) \\ {y}^{( 5 )} ( 4 i + 3 ) \\ {y}^{( 6 )} ( 4 i + 3 ) \\ {y}^{( 7 )} ( 4 i + 3 )\end{matrix} ] = \frac{1}{\sqrt{4}} [ \begin{matrix}0 & 0 & 0 & 0 & 0 & 0 & 0 & 0 \\ 0 & 0 & 1 & 0 & 0 & 0 & 1 & 0 \\ 0 & 0 & 0 & 0 & 0 & 0 & 0 & 0 \\ 0 & 0 & 0 & - 1 & 0 & 0 & 0 & 1 \\ 0 & 0 & 0 & 0 & 0 & 0 & 0 & 0 \\ 0 & 0 & {e}^{{jθ}_{1} {k}_{4 i + 2}} & 0 & 0 & 0 & {e}^{{jθ}_{1} {k}_{4 i + 2}} & 0 \\ 0 & 0 & 0 & 0 & 0 & 0 & 0 & 0 \\ 0 & 0 & 0 & - {e}^{j ( {θ}_{2} {k}_{4 i + 2} + φ )} & 0 & 0 & 0 & {e}^{j ( {θ}_{2} {k}_{4 i + 2} + φ )} \\ 0 & 0 & 0 & 0 & 0 & 0 & 0 & 0 \\ 0 & 0 & 0 & 1 & 0 & 0 & 0 & 1 \\ 0 & 0 & 0 & 0 & 0 & 0 & 0 & 0 \\ 0 & 0 & 1 & 0 & 0 & 0 & - 1 & 0 \\ 0 & 0 & 0 & 0 & 0 & 0 & 0 & 0 \\ 0 & 0 & 0 & - {e}^{{jθ}_{1} {k}_{4 i + 2}} & 0 & 0 & 0 & - {e}^{{jθ}_{1} {k}_{4 i + 2}} \\ 0 & 0 & 0 & 0 & 0 & 0 & 0 & 0 \\ 0 & 0 & {e}^{j ( {θ}_{2} {k}_{4 i + 2} + φ )} & 0 & 0 & 0 & - {e}^{j ( {θ}_{2} {k}_{4 i + 2} + φ )} & 0\end{matrix} ] [ \begin{matrix}Re ( {x}^{( 0 )} ( i ) ) \\ Re ( {x}^{( 1 )} ( i ) ) \\ Re ( {x}^{( 2 )} ( i ) ) \\ Re ( {x}^{( 3 )} ( i ) ) \\ Im ( {x}^{( 0 )} ( i ) ) \\ Im ( {x}^{( 1 )} ( i ) ) \\ Im ( {x}^{( 2 )} ( i ) ) \\ Im ( {x}^{( 3 )} ( i ) )\end{matrix} ] . & [ Eqn . 32 ]\end{matrix}$$

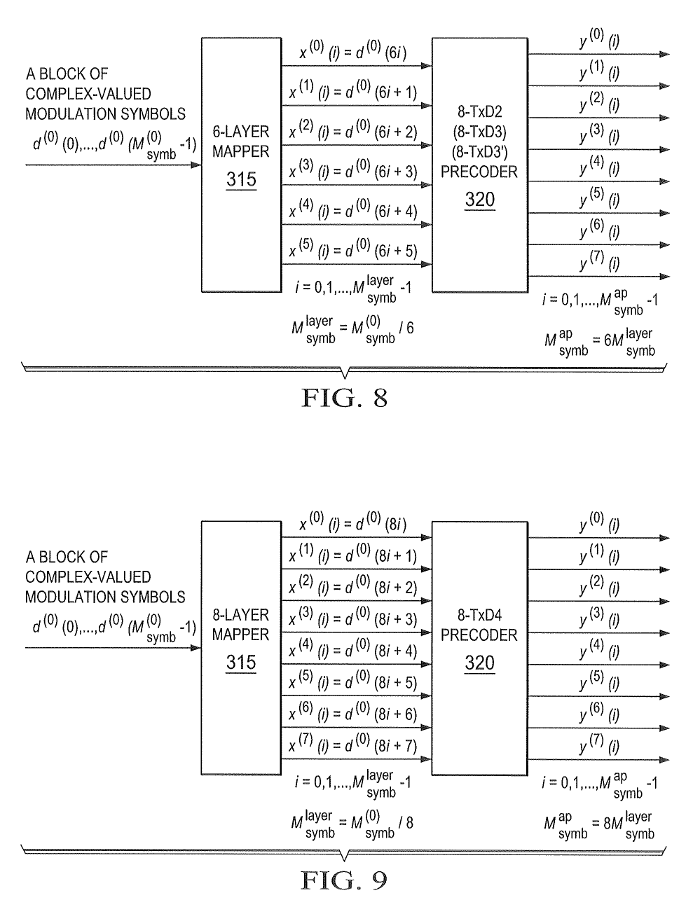

FIG. 8 illustrates details of yet another layer mapper 315 and precoder 320 of FIG. 3 according to one embodiment of the present disclosure. The embodiment of the layer mapper 315 and precoder 320 shown in FIG. 8 is for illustration only. Other embodiments of the layer mapper 315 and precoder 320 could be used without departing from the scope of this disclosure.

In some embodiments, ν=6 signal layers are constructed for 8-TxD precoding. In such embodiments, the layer mapper 315 is a 6-layer mapper and the precoder 320 is a 8-TxD2 precoder. Further, two precoded matrices, X₁ and X₂ , are constructed by signal layers 1 and 2, while the other two precoded signal matrices, X₃ and X₄, are constructed by the signal layers 3, 4, 5 and 6. SFBC-FSTD, SFBC-PSD3, SFBC-PSD3 and SFBC-FSTD are used for the construction of X₁, X₂, X₃ and X₄, respectively. In such embodiments, codeword-to-layer mapping and preceding operation is illustrated in FIG. 8 and the precoded signal matrix (denoted by X_{8TxD2}) is defined by Equation 33:

$$[ \begin{matrix}{y}^{( 0 )} ( 6 i ) & {y}^{( 0 )} ( 6 i + 1 ) & {y}^{( 0 )} ( 6 i + 2 ) & {y}^{( 0 )} ( 6 i + 3 ) & {y}^{( 0 )} ( 6 i + 4 ) & {y}^{( 0 )} ( 6 i + 5 ) \\ {y}^{( 1 )} ( 6 i ) & {y}^{( 1 )} ( 6 i + 1 ) & {y}^{( 1 )} ( 6 i + 2 ) & {y}^{( 1 )} ( 6 i + 3 ) & {y}^{( 1 )} ( 6 i + 4 ) & {y}^{( 1 )} ( 6 i + 5 ) \\ {y}^{( 2 )} ( 6 i ) & {y}^{( 2 )} ( 6 i + 1 ) & {y}^{( 2 )} ( 6 i + 2 ) & {y}^{( 2 )} ( 6 i + 3 ) & {y}^{( 2 )} ( 6 i + 4 ) & {y}^{( 2 )} ( 6 i + 5 ) \\ {y}^{( 3 )} ( 6 i ) & {y}^{( 3 )} ( 6 i + 1 ) & {y}^{( 3 )} ( 6 i + 2 ) & {y}^{( 3 )} ( 6 i + 3 ) & {y}^{( 3 )} ( 6 i + 4 ) & {y}^{( 3 )} ( 6 i + 5 ) \\ {y}^{( 4 )} ( 6 i ) & {y}^{( 4 )} ( 6 i + 1 ) & {y}^{( 4 )} ( 6 i + 2 ) & {y}^{( 4 )} ( 6 i + 3 ) & {y}^{( 4 )} ( 6 i + 4 ) & {y}^{( 4 )} ( 6 i + 5 ) \\ {y}^{( 5 )} ( 6 i ) & {y}^{( 5 )} ( 6 i + 1 ) & {y}^{( 5 )} ( 6 i + 2 ) & {y}^{( 5 )} ( 6 i + 3 ) & {y}^{( 5 )} ( 6 i + 4 ) & {y}^{( 5 )} ( 6 i + 5 ) \\ {y}^{( 6 )} ( 6 i ) & {y}^{( 6 )} ( 6 i + 1 ) & {y}^{( 6 )} ( 6 i + 2 ) & {y}^{( 6 )} ( 6 i + 3 ) & {y}^{( 6 )} ( 6 i + 4 ) & {y}^{( 6 )} ( 6 i + 5 ) \\ {y}^{( 7 )} ( 6 i ) & {y}^{( 7 )} ( 6 i + 1 ) & {y}^{( 7 )} ( 6 i + 2 ) & {y}^{( 7 )} ( 6 i + 3 ) & {y}^{( 7 )} ( 6 i + 4 ) & {y}^{( 7 )} ( 6 i + 5 )\end{matrix} ] = {X}_{8 T \times D 2} ( i ) ≡ [ \begin{matrix}{x}^{( 0 )} ( i ) & {x}^{( 1 )} ( i ) & {x}^{( 2 )} ( i ) & {x}^{( 3 )} ( i ) & 0 & 0 \\ {x}^{( 0 )} ( i ) {e}^{{jθ}_{1} {k}_{6 i}} & - {x}^{( 1 )} ( i ) {e}^{{jθ}_{1} {k}_{6 i}} & 0 & 0 & {x}^{( 4 )} ( i ) & {x}^{( 5 )} ( i ) \\ - {( {x}^{( 1 )} ( i ) )}^{*} & {( {x}^{( 0 )} ( i ) )}^{*} & - {( {x}^{( 3 )} ( i ) )}^{*} & {( {x}^{( 2 )} ( i ) )}^{*} & 0 & 0 \\ - {( {x}^{( 1 )} ( i ) )}^{*} {e}^{j ( {θ}_{2} {k}_{6 i} + φ )} & {( {x}^{( 0 )} ( i ) )}^{*} {e}^{j ( {θ}_{2} {k}_{6 i} + φ )} & 0 & 0 & - {( {x}^{( 5 )} ( i ) )}^{*} & {( {x}^{( 4 )} ( i ) )}^{*} \\ {x}^{( 0 )} ( i ) & {x}^{( 1 )} ( i ) & {x}^{( 2 )} ( i ) & {x}^{( 3 )} ( i ) & 0 & 0 \\ {x}^{( 0 )} ( i ) {e}^{{jθ}_{1} {k}_{6 i}} & - {x}^{( 1 )} ( i ) {e}^{{jθ}_{1} {k}_{6 i}} & 0 & 0 & {x}^{( 4 )} ( i ) & {x}^{( 5 )} ( i ) \\ - {( {x}^{( 1 )} ( i ) )}^{*} & {( {x}^{( 0 )} ( i ) )}^{*} & - {( {x}^{( 3 )} ( i ) )}^{*} & {( {x}^{( 2 )} ( i ) )}^{*} & 0 & 0 \\ - {( {x}^{( 1 )} ( i ) )}^{*} {e}^{j ( {θ}_{2} {k}_{6 i} + φ )} & {( {x}^{( 0 )} ( i ) )}^{*} {e}^{j ( {θ}_{2} {k}_{6 i} + φ )} & 0 & 0 & - {( {x}^{( 5 )} ( i ) )}^{*} & {( {x}^{( 4 )} ( i ) )}^{*}\end{matrix} ] , \qquad [ Eqn . 33 ]$$

In Equation 33, i=0,1, . . . , M_{symb}^{ap} −1, M_{symb}^{layer}, k₆ᵢ is a physical subcarrier index associated with data subcarrier index 6i,6i+1, . . . , 6i+5.

In yet another embodiment, X₂ and X₃ are zero matrices and ν=6 signal layers are constructed for 8-TxD preceding. In such embodiments, the layer mapper 315 is a 6-layer mapper and the precoder 320 is a 8-TxD3 precoder. Then, a block diagonal precoded signal matrix is obtained and defined by Equation 34:

$${X}_{8 T \times D 3} = [ \begin{matrix}{X}_{1} & {0}_{4 \times 2} \\ {0}_{4 \times 4} & {X}_{4}\end{matrix} ] . \qquad [ Eqn . 34 ]$$

X₁ is constructed by SFBC-FSTD, while X₄ is constructed by SFBC-PSD3. Then, codeword-to-layer mapping and precoding operation is illustrated in FIG. 8 and the precoded signal matrix (denoted by X_{8TxD3}) is defined by Equation 35:

$$[ \begin{matrix}{y}^{( 0 )} ( 6 i ) & {y}^{( 0 )} ( 6 i + 1 ) & {y}^{( 0 )} ( 6 i + 2 ) & {y}^{( 0 )} ( 6 i + 3 ) & {y}^{( 0 )} ( 6 i + 4 ) & {y}^{( 0 )} ( 6 i + 5 ) \\ {y}^{( 1 )} ( 6 i ) & {y}^{( 1 )} ( 6 i + 1 ) & {y}^{( 1 )} ( 6 i + 2 ) & {y}^{( 1 )} ( 6 i + 3 ) & {y}^{( 1 )} ( 6 i + 4 ) & {y}^{( 1 )} ( 6 i + 5 ) \\ {y}^{( 2 )} ( 6 i ) & {y}^{( 2 )} ( 6 i + 1 ) & {y}^{( 2 )} ( 6 i + 2 ) & {y}^{( 2 )} ( 6 i + 3 ) & {y}^{( 2 )} ( 6 i + 4 ) & {y}^{( 2 )} ( 6 i + 5 ) \\ {y}^{( 3 )} ( 6 i ) & {y}^{( 3 )} ( 6 i + 1 ) & {y}^{( 3 )} ( 6 i + 2 ) & {y}^{( 3 )} ( 6 i + 3 ) & {y}^{( 3 )} ( 6 i + 4 ) & {y}^{( 3 )} ( 6 i + 5 ) \\ {y}^{( 4 )} ( 6 i ) & {y}^{( 4 )} ( 6 i + 1 ) & {y}^{( 4 )} ( 6 i + 2 ) & {y}^{( 4 )} ( 6 i + 3 ) & {y}^{( 4 )} ( 6 i + 4 ) & {y}^{( 4 )} ( 6 i + 5 ) \\ {y}^{( 5 )} ( 6 i ) & {y}^{( 5 )} ( 6 i + 1 ) & {y}^{( 5 )} ( 6 i + 2 ) & {y}^{( 5 )} ( 6 i + 3 ) & {y}^{( 5 )} ( 6 i + 4 ) & {y}^{( 5 )} ( 6 i + 5 ) \\ {y}^{( 6 )} ( 6 i ) & {y}^{( 6 )} ( 6 i + 1 ) & {y}^{( 6 )} ( 6 i + 2 ) & {y}^{( 6 )} ( 6 i + 3 ) & {y}^{( 6 )} ( 6 i + 4 ) & {y}^{( 6 )} ( 6 i + 5 ) \\ {y}^{( 7 )} ( 6 i ) & {y}^{( 7 )} ( 6 i + 1 ) & {y}^{( 7 )} ( 6 i + 2 ) & {y}^{( 7 )} ( 6 i + 3 ) & {y}^{( 7 )} ( 6 i + 4 ) & {y}^{( 7 )} ( 6 i + 5 )\end{matrix} ] = {X}_{8 T \times D 3} ( i ) ≡ \\ [ \begin{matrix}\begin{matrix}{x}^{( 0 )} ( i ) & {x}^{( 1 )} ( i ) & 0 & 0 \\ 0 & 0 & {x}^{( 2 )} ( i ) & {x}^{( 3 )} ( i ) \\ - {( {x}^{( 1 )} ( i ) )}^{*} & {( {x}^{( 0 )} ( i ) )}^{*} & 0 & 0 \\ 0 & 0 & - {( {x}^{( 3 )} ( i ) )}^{*} & {( {x}^{( 2 )} ( i ) )}^{*}\end{matrix} & 0 \\ 0 & \begin{matrix}{x}^{( 4 )} ( i ) & {x}^{( 5 )} ( i ) \\ - {( {x}^{( 5 )} ( i ) )}^{*} & {( {x}^{( 4 )} ( i ) )}^{*} \\ {x}^{( 4 )} ( i ) {e}^{{jθ}_{1} {k}_{6 i}} & - {x}^{( 5 )} ( i ) {e}^{{jθ}_{1} {k}_{6 i}} \\ - {( {x}^{( 5 )} ( i ) )}^{*} {e}^{j ( {θ}_{2} {k}_{6 i} + φ )} & {( {x}^{( 4 )} ( i ) )}^{*} {e}^{j ( {θ}_{2} {k}_{6 i} + φ )}\end{matrix}\end{matrix} ] , \qquad [ Eqn . 35 ]$$

In Equation 35, i=0,1, . . . , M_{symb}^{ap}−1, M_{symb}^{ap}=6M_{symb}^{layer}, k₆ᵢ is a physical subcarrier index associated with data subcarrier index 6i,6i+1, . . . , 6i+5.

In another embodiment, X₂ and X₃ are zero matrices and ν=6 signal layers are constructed for 8-TxD precoding. In such embodiments, the layer mapper 315 is a 6-layer mapper and the precoder 320 is a 8-TxD3′ precoder. Then, a block diagonal precoded signal matrix is obtained and defined by Equation 36:

$${X}_{8 T \times D 3}^{′} = [ \begin{matrix}{X}_{1} & {0}_{4 \times 4} \\ {0}_{4 \times 2} & {X}_{4}\end{matrix} ] . \qquad [ Eqn . 36 ]$$

X₁ is constructed by SFBC-PSD3, while X₄ is constructed by SFBC-FSTD. In such embodiment, codeword-to-layer mapping and preceding operation is illustrated in FIG. 8 and the precoded signal matrix (denoted by X′_{8TxD3}) is defined by Equation 37:

$$[ \begin{matrix}{y}^{( 0 )} ( 6 i ) & {y}^{( 0 )} ( 6 i + 1 ) & {y}^{( 0 )} ( 6 i + 2 ) & {y}^{( 0 )} ( 6 i + 3 ) & {y}^{( 0 )} ( 6 i + 4 ) & {y}^{( 0 )} ( 6 i + 5 ) \\ {y}^{( 1 )} ( 6 i ) & {y}^{( 1 )} ( 6 i + 1 ) & {y}^{( 1 )} ( 6 i + 2 ) & {y}^{( 1 )} ( 6 i + 3 ) & {y}^{( 1 )} ( 6 i + 4 ) & {y}^{( 1 )} ( 6 i + 5 ) \\ {y}^{( 2 )} ( 6 i ) & {y}^{( 2 )} ( 6 i + 1 ) & {y}^{( 2 )} ( 6 i + 2 ) & {y}^{( 2 )} ( 6 i + 3 ) & {y}^{( 2 )} ( 6 i + 4 ) & {y}^{( 2 )} ( 6 i + 5 ) \\ {y}^{( 3 )} ( 6 i ) & {y}^{( 3 )} ( 6 i + 1 ) & {y}^{( 3 )} ( 6 i + 2 ) & {y}^{( 3 )} ( 6 i + 3 ) & {y}^{( 3 )} ( 6 i + 4 ) & {y}^{( 3 )} ( 6 i + 5 ) \\ {y}^{( 4 )} ( 6 i ) & {y}^{( 4 )} ( 6 i + 1 ) & {y}^{( 4 )} ( 6 i + 2 ) & {y}^{( 4 )} ( 6 i + 3 ) & {y}^{( 4 )} ( 6 i + 4 ) & {y}^{( 4 )} ( 6 i + 5 ) \\ {y}^{( 5 )} ( 6 i ) & {y}^{( 5 )} ( 6 i + 1 ) & {y}^{( 5 )} ( 6 i + 2 ) & {y}^{( 5 )} ( 6 i + 3 ) & {y}^{( 5 )} ( 6 i + 4 ) & {y}^{( 5 )} ( 6 i + 5 ) \\ {y}^{( 6 )} ( 6 i ) & {y}^{( 6 )} ( 6 i + 1 ) & {y}^{( 6 )} ( 6 i + 2 ) & {y}^{( 6 )} ( 6 i + 3 ) & {y}^{( 6 )} ( 6 i + 4 ) & {y}^{( 6 )} ( 6 i + 5 ) \\ {y}^{( 7 )} ( 6 i ) & {y}^{( 7 )} ( 6 i + 1 ) & {y}^{( 7 )} ( 6 i + 2 ) & {y}^{( 7 )} ( 6 i + 3 ) & {y}^{( 7 )} ( 6 i + 4 ) & {y}^{( 7 )} ( 6 i + 5 )\end{matrix} ] = {X}_{8 T \times D 3}^{′} ( i ) ≡ \\ [ \begin{matrix}\begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{{jθ}_{1} {k}_{6 i}} & - {x}^{( 1 )} ( i ) {e}^{{jθ}_{1} {k}_{6 i}} \\ - {( {x}^{( 1 )} ( i ) )}^{*} {e}^{j ( {θ}_{2} {k}_{6 i} + φ )} & {( {x}^{( 0 )} ( i ) )}^{*} {e}^{j ( {θ}_{2} {k}_{6 i} + φ )}\end{matrix} & 0 \\ 0 & \begin{matrix}{x}^{( 2 )} ( i ) & {x}^{( 3 )} ( i ) & 0 & 0 \\ 0 & 0 & {x}^{( 4 )} ( i ) & {x}^{( 5 )} ( i ) \\ - {( {x}^{( 3 )} ( i ) )}^{*} & {( {x}^{( 2 )} ( i ) )}^{*} & 0 & 0 \\ 0 & 0 & - {( {x}^{( 5 )} ( i ) )}^{*} & {( {x}^{( 4 )} ( i ) )}^{*}\end{matrix}\end{matrix} ] , . \qquad [ Eqn . 37 ]$$

In Equation 37 i=0,1, . . . , M_{symb}^{ap}−1, M_{symb}^{ap}=6M_{symb}^{layer}, k₆ᵢ is a physical subcarrier index associated with data subcarrier index 6i,6i+1, . . . , 6i+5.

FIG. 9 illustrates details of yet another layer mapper 315 and precoder 320 of FIG. 3 according to one embodiment of the present disclosure. The embodiment of the layer mapper 315 and precoder 320 shown in FIG. 9 is for illustration only. Other embodiments of the layer mapper 315 and precoder 320 could be used without departing from the scope of this disclosure.

In some embodiments, the layer mapper 315 is an 8-layer mapper and the precoder 320 is a 8-TxD4 precoder. Further, X₂ and X₃ are zero matrices and u=8 signal layers are constructed for 8-TxD preceding. Then, a block diagonal precoded signal matrix is obtained and defined by Equation 38:

$${X}_{8 T \times D 4} = [ \begin{matrix}{X}_{1} & {0}_{4 \times 4} \\ {0}_{4 \times 4} & {X}_{4}\end{matrix} ] \qquad [ Eqn . 38 ]$$

In Equation 38, 0_{4×4} is a 4×4 zero matrix. SFBC-FSTD is used to construct both X₁ and X₄. Then, codeword-to-layer mapping and preceding operation is illustrated in FIG. 9 and the precoded signal matrix (denoted by X_{8TxD4}) is defined by Equation 39:

$$[ \begin{matrix}{y}^{( 0 )} ( 8 i ) & {y}^{( 0 )} ( 8 i + 1 ) & {y}^{( 0 )} ( 8 i + 2 ) & {y}^{( 0 )} ( 8 i + 3 ) & {y}^{( 0 )} ( 8 i + 4 ) & {y}^{( 0 )} ( 8 i + 5 ) & {y}^{( 0 )} ( 8 i + 6 ) & {y}^{( 0 )} ( 8 i + 7 ) \\ {y}^{( 1 )} ( 8 i ) & {y}^{( 1 )} ( 8 i + 1 ) & {y}^{( 1 )} ( 8 i + 2 ) & {y}^{( 1 )} ( 8 i + 3 ) & {y}^{( 1 )} ( 8 i + 4 ) & {y}^{( 1 )} ( 8 i + 5 ) & {y}^{( 1 )} ( 8 i + 6 ) & {y}^{( 1 )} ( 8 i + 7 ) \\ {y}^{( 2 )} ( 8 i ) & {y}^{( 2 )} ( 8 i + 1 ) & {y}^{( 2 )} ( 8 i + 2 ) & {y}^{( 2 )} ( 8 i + 3 ) & {y}^{( 2 )} ( 8 i + 4 ) & {y}^{( 2 )} ( 8 i + 5 ) & {y}^{( 2 )} ( 8 i + 6 ) & {y}^{( 2 )} ( 8 i + 7 ) \\ {y}^{( 3 )} ( 8 i ) & {y}^{( 3 )} ( 8 i + 1 ) & {y}^{( 3 )} ( 8 i + 2 ) & {y}^{( 3 )} ( 8 i + 3 ) & {y}^{( 3 )} ( 8 i + 4 ) & {y}^{( 3 )} ( 8 i + 5 ) & {y}^{( 3 )} ( 8 i + 6 ) & {y}^{( 3 )} ( 8 i + 7 ) \\ {y}^{( 4 )} ( 8 i ) & {y}^{( 4 )} ( 8 i + 1 ) & {y}^{( 4 )} ( 8 i + 2 ) & {y}^{( 4 )} ( 8 i + 3 ) & {y}^{( 4 )} ( 8 i + 4 ) & {y}^{( 4 )} ( 8 i + 5 ) & {y}^{( 4 )} ( 8 i + 6 ) & {y}^{( 4 )} ( 8 i + 7 ) \\ {y}^{( 5 )} ( 8 i ) & {y}^{( 5 )} ( 8 i + 1 ) & {y}^{( 5 )} ( 8 i + 2 ) & {y}^{( 5 )} ( 8 i + 3 ) & {y}^{( 5 )} ( 8 i + 4 ) & {y}^{( 5 )} ( 8 i + 5 ) & {y}^{( 5 )} ( 8 i + 6 ) & {y}^{( 5 )} ( 8 i + 7 ) \\ {y}^{( 6 )} ( 8 i ) & {y}^{( 6 )} ( 8 i + 1 ) & {y}^{( 6 )} ( 8 i + 2 ) & {y}^{( 6 )} ( 8 i + 3 ) & {y}^{( 6 )} ( 8 i + 4 ) & {y}^{( 6 )} ( 8 i + 5 ) & {y}^{( 6 )} ( 8 i + 6 ) & {y}^{( 6 )} ( 8 i + 7 ) \\ {y}^{( 7 )} ( 8 i ) & {y}^{( 7 )} ( 8 i + 1 ) & {y}^{( 7 )} ( 8 i + 2 ) & {y}^{( 7 )} ( 8 i + 3 ) & {y}^{( 7 )} ( 8 i + 4 ) & {y}^{( 7 )} ( 8 i + 5 ) & {y}^{( 7 )} ( 8 i + 6 ) & {y}^{( 7 )} ( 8 i + 7 )\end{matrix} ] = {X}_{8 T \times D 4} ( i ) ≡ [ \begin{matrix}\begin{matrix}{x}^{( 0 )} ( i ) & {x}^{( 1 )} ( i ) & 0 & 0 \\ 0 & 0 & {x}^{( 2 )} ( i ) & {x}^{( 3 )} ( i ) \\ - {( {x}^{( 1 )} ( i ) )}^{*} & {( {x}^{( 0 )} ( i ) )}^{*} & 0 & 0 \\ 0 & 0 & - {( {x}^{( 3 )} ( i ) )}^{*} & {( {x}^{( 2 )} ( i ) )}^{*}\end{matrix} & 0 \\ 0 & \begin{matrix}{x}^{( 4 )} ( i ) & {x}^{( 5 )} ( i ) & 0 & 0 \\ 0 & 0 & {x}^{( 6 )} ( i ) & {x}^{( 7 )} ( i ) \\ - {( {x}^{( 5 )} ( i ) )}^{*} & {( {x}^{( 4 )} ( i ) )}^{*} & 0 & 0 \\ 0 & 0 & - {( {x}^{( 7 )} ( i ) )}^{*} & {( {x}^{( 6 )} ( i ) )}^{*}\end{matrix}\end{matrix} ] . \qquad [ Eqn . 39 ]$$

In Equation 39, i=0,1, . . . , M_{symb}^{ap}−1, M_{symb}^{ap}=8M_{symb}^{layer}, Equation 39 can be rewritten as Equations 40 and 41:

$$\begin{matrix}[ \begin{matrix}{y}^{( 0 )} ( 8 i ) \\ {y}^{( 1 )} ( 8 i ) \\ {y}^{( 2 )} ( 8 i ) \\ {y}^{( 3 )} ( 8 i ) \\ {y}^{( 0 )} ( 8 i + 1 ) \\ {y}^{( 1 )} ( 8 i + 1 ) \\ {y}^{( 2 )} ( 8 i + 1 ) \\ {y}^{( 3 )} ( 8 i + 1 ) \\ {y}^{( 0 )} ( 8 i + 2 ) \\ {y}^{( 1 )} ( 8 i + 2 ) \\ {y}^{( 2 )} ( 8 i + 2 ) \\ {y}^{( 3 )} ( 8 i + 2 ) \\ {y}^{( 0 )} ( 8 i + 3 ) \\ {y}^{( 1 )} ( 8 i + 3 ) \\ {y}^{( 2 )} ( 8 i + 3 ) \\ {y}^{( 3 )} ( 8 i + 3 )\end{matrix} ] = \frac{1}{\sqrt{2}} [ \begin{matrix}1 & 0 & 0 & 0 & j & 0 & 0 & 0 \\ 0 & 0 & 0 & 0 & 0 & 0 & 0 & 0 \\ 0 & - 1 & 0 & 0 & 0 & j & 0 & 0 \\ 0 & 0 & 0 & 0 & 0 & 0 & 0 & 0 \\ 0 & 1 & 0 & 0 & 0 & j & 0 & 0 \\ 0 & 0 & 0 & 0 & 0 & 0 & 0 & 0 \\ 1 & 0 & 0 & 0 & - j & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 1 & 0 & 0 & 0 & j & 0 \\ 0 & 0 & 0 & 0 & 0 & 0 & 0 & 0 \\ 0 & 0 & 0 & - 1 & 0 & 0 & 0 & j \\ 0 & 0 & 0 & 0 & 0 & 0 & 0 & 0 \\ 0 & 0 & 0 & 1 & 0 & 0 & 0 & j \\ 0 & 0 & 0 & 0 & 0 & 0 & 0 & 0 \\ 0 & 0 & 1 & 0 & 0 & 0 & - j & 0\end{matrix} ] [ \begin{matrix}Re ( {x}^{( 0 )} ( i ) ) \\ Re ( {x}^{( 1 )} ( i ) ) \\ Re ( {x}^{( 2 )} ( i ) ) \\ Re ( {x}^{( 3 )} ( i ) ) \\ Im ( {x}^{( 0 )} ( i ) ) \\ Im ( {x}^{( 1 )} ( i ) ) \\ Im ( {x}^{( 2 )} ( i ) ) \\ Im ( {x}^{( 3 )} ( i ) )\end{matrix} ] ; \\ and \\ & [ Eqn . 40 ] \\ [ \begin{matrix}{y}^{( 0 )} ( 8 i + 4 ) \\ {y}^{( 1 )} ( 8 i + 4 ) \\ {y}^{( 2 )} ( 8 i + 4 ) \\ {y}^{( 3 )} ( 8 i + 4 ) \\ {y}^{( 0 )} ( 8 i + 5 ) \\ {y}^{( 1 )} ( 8 i + 5 ) \\ {y}^{( 2 )} ( 8 i + 5 ) \\ {y}^{( 3 )} ( 8 i + 5 ) \\ {y}^{( 0 )} ( 8 i + 6 ) \\ {y}^{( 1 )} ( 8 i + 6 ) \\ {y}^{( 2 )} ( 8 i + 6 ) \\ {y}^{( 3 )} ( 8 i + 6 ) \\ {y}^{( 0 )} ( 8 i + 7 ) \\ {y}^{( 1 )} ( 8 i + 7 ) \\ {y}^{( 2 )} ( 8 i + 7 ) \\ {y}^{( 3 )} ( 8 i + 7 )\end{matrix} ] = \frac{1}{\sqrt{2}} [ \begin{matrix}1 & 0 & 0 & 0 & j & 0 & 0 & 0 \\ 0 & 0 & 0 & 0 & 0 & 0 & 0 & 0 \\ 0 & - 1 & 0 & 0 & 0 & j & 0 & 0 \\ 0 & 0 & 0 & 0 & 0 & 0 & 0 & 0 \\ 0 & 1 & 0 & 0 & 0 & j & 0 & 0 \\ 0 & 0 & 0 & 0 & 0 & 0 & 0 & 0 \\ 1 & 0 & 0 & 0 & - j & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 1 & 0 & 0 & 0 & j & 0 \\ 0 & 0 & 0 & 0 & 0 & 0 & 0 & 0 \\ 0 & 0 & 0 & - 1 & 0 & 0 & 0 & j \\ 0 & 0 & 0 & 0 & 0 & 0 & 0 & 0 \\ 0 & 0 & 0 & 1 & 0 & 0 & 0 & j \\ 0 & 0 & 0 & 0 & 0 & 0 & 0 & 0 \\ 0 & 0 & 1 & 0 & 0 & 0 & - j & 0\end{matrix} ] [ \begin{matrix}Re ( {x}^{( 4 )} ( i ) ) \\ Re ( {x}^{( 5 )} ( i ) ) \\ Re ( {x}^{( 6 )} ( i ) ) \\ Re ( {x}^{( 7 )} ( i ) ) \\ Im ( {x}^{( 4 )} ( i ) ) \\ Im ( {x}^{( 5 )} ( i ) ) \\ Im ( {x}^{( 6 )} ( i ) ) \\ Im ( {x}^{( 7 )} ( i ) )\end{matrix} ] . & [ Eqn . 41 ]\end{matrix}$$

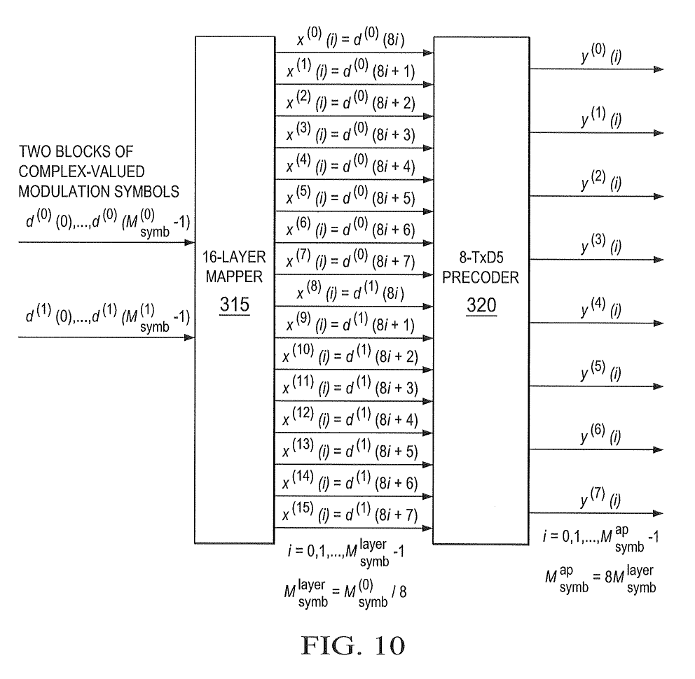

FIG. 10 illustrates details of yet another layer mapper 315 and precoder 320 of FIG. 3 according to one embodiment of the present disclosure. The embodiment of the layer mapper 315 and precoder 320 shown in FIG. 10 is for illustration only. Other embodiments of the layer mapper 315 and precoder 320 could be used without departing from the scope of this disclosure.

In some embodiments, the layer mapper 315 is a 16-layer mapper and the precoder 320 is a 8-TxD5 precoder. Further X₂ and X₃ are zero matrices and ν=16 signal layers are constructed for 8-TxD precoding. Then, a block diagonal precoded signal matrix is obtained and defined by Equation 42:

$$[ \begin{matrix}{Y}_{1} ( i ) & {Y}_{2} ( i ) \\ {Y}_{3} ( i ) & {Y}_{4} ( i )\end{matrix} ] = {X}_{8 T \times D 5} ( i ) ≡ [ \begin{matrix}{X}_{1} ( i ) & {0}_{4 \times 4} \\ {0}_{4 \times 4} & {X}_{4} ( i )\end{matrix} ] . \qquad [ Eqn . 42 ]$$

In Equation 38, 0_{4×4} is a 4×4 zero matrix. The Golden Code is used to construct both X₁(i) and X₄(i), and define codeword-to-layer mapping for this precoding operation with ν=16 signal layers, according to Table 3. The codeword-to-layer mapping and preceding operation is illustrated in FIG. 10.

TABLE 3
Codeword-to-layer mapping for transmit diversity 8-TxD5

| | Number | | | |
|---|---|---|---|---|
| Number of | of code | Codeword-to-layer mapping | | |
| layers | words | i = 0, 1, . . . , M_{symb}^{layer} − 1 | | |
| 16 | 2 | x⁽⁰⁾ (i) = d⁽⁰⁾ (8i) | x⁽⁸⁾ (i) = d⁽¹⁾ (8i) | M_{symb}^{layer} = M_{symb}⁽⁰⁾/16 |
| | | x⁽¹⁾ (i) = d⁽⁰⁾ (8i + 1) | x⁽⁹⁾ (i) = d⁽¹⁾ (8i + 1) | |
| | | x⁽²⁾ (i) = d⁽⁰⁾ (8i + 2) | x⁽¹⁰⁾ (i) = d⁽¹⁾ (8i + 2) | |
| | | x⁽³⁾ (i) = d⁽⁰⁾ (8i + 3) | x⁽¹¹⁾ (i) = d⁽¹⁾ (8i + 3) | |
| | | x⁽⁴⁾ (i) = d⁽⁰⁾ (8i + 4) | x⁽¹²⁾ (i) = d⁽¹⁾ (8i + 4) | |
| | | x⁽⁵⁾ (i) = d⁽⁰⁾ (8i + 5) | x⁽¹³⁾ (i) = d⁽¹⁾ (8i + 5) | |
| | | x⁽⁶⁾ (i) = d⁽⁰⁾ (8i + 6) | x⁽¹⁴⁾ (i) = d⁽¹⁾ (8i + 6) | |
| | | x⁽⁷⁾ (i) = d⁽⁰⁾ (8i + 7) | x⁽¹⁵⁾ (i) = d⁽¹⁾ (8i + 7) | |

For example, when X₁ is constructed, two Golden code constructions are used for the first and the second four signal layers (i.e., layers 0 through 7), in block diagonal fashion as illustrated by Equations 43 and 44:

$$\begin{matrix}{Y}_{1} ( i ) = [ \begin{matrix}{y}^{( 0 )} ( 8 i ) & {y}^{( 0 )} ( 8 i + 1 ) & {y}^{( 0 )} ( 8 i + 2 ) & {y}^{( 0 )} ( 8 i + 3 ) \\ {y}^{( 1 )} ( 8 i ) & {y}^{( 1 )} ( 8 i + 1 ) & {y}^{( 1 )} ( 8 i + 2 ) & {y}^{( 1 )} ( 8 i + 3 ) \\ {y}^{( 2 )} ( 8 i ) & {y}^{( 2 )} ( 8 i + 1 ) & {y}^{( 2 )} ( 8 i + 2 ) & {y}^{( 2 )} ( 8 i + 3 ) \\ {y}^{( 3 )} ( 8 i ) & {y}^{( 3 )} ( 8 i + 1 ) & {y}^{( 3 )} ( 8 i + 2 ) & {y}^{( 3 )} ( 8 i + 3 )\end{matrix} ] = {X}_{1} ( i ) ≡ \\ [ \begin{matrix}( 1 + j \overline{g} ) ( \begin{matrix}{x}^{( 0 )} ( i ) + \\ {x}^{( 1 )} ( i ) g\end{matrix} ) & & ( 1 + j \overline{g} ) ( \begin{matrix}{x}^{( 2 )} ( i ) + \\ {x}^{( 3 )} ( i ) g\end{matrix} ) & & & \\ ( 1 + jg ) ( \begin{matrix}{x}^{( 2 )} ( i ) + \\ {x}^{( 3 )} ( i ) \overline{g}\end{matrix} ) & & ( 1 + jg ) ( \begin{matrix}{x}^{( 0 )} ( i ) + \\ {x}^{( 1 )} ( i ) \overline{g}\end{matrix} ) & & 0 & \\ & 0 & & ( 1 + j \overline{g} ) ( \begin{matrix}{x}^{( 4 )} ( i ) + \\ {x}^{( 5 )} ( i ) g\end{matrix} ) & & ( 1 + j \overline{g} ) ( \begin{matrix}{x}^{( 6 )} ( i ) + \\ {x}^{( 7 )} ( i ) g\end{matrix} ) \\ & & & ( 1 + jg ) ( \begin{matrix}{x}^{( 6 )} ( i ) + \\ {x}^{( 7 )} ( i ) \overline{g}\end{matrix} ) & & ( 1 + jg ) ( \begin{matrix}{x}^{( 4 )} ( i ) + \\ {x}^{( 5 )} ( i ) \overline{g}\end{matrix} )\end{matrix} ] , \\ and & [ Eqn . 43 ] \\ {Y}_{4} ( i ) = [ \begin{matrix}{y}^{( 4 )} ( 8 i + 4 ) & {y}^{( 4 )} ( 8 i + 5 ) & {y}^{( 4 )} ( 8 i + 6 ) & {y}^{( 4 )} ( 8 i + 7 ) \\ {y}^{( 5 )} ( 8 i + 4 ) & {y}^{( 5 )} ( 8 i + 5 ) & {y}^{( 5 )} ( 8 i + 6 ) & {y}^{( 5 )} ( 8 i + 7 ) \\ {y}^{( 6 )} ( 8 i + 4 ) & {y}^{( 6 )} ( 8 i + 5 ) & {y}^{( 6 )} ( 8 i + 6 ) & {y}^{( 6 )} ( 8 i + 7 ) \\ {y}^{( 7 )} ( 8 i + 4 ) & {y}^{( 7 )} ( 8 i + 5 ) & {y}^{( 7 )} ( 8 i + 6 ) & {y}^{( 7 )} ( 8 i + 7 )\end{matrix} ] = {X}_{4} ( i ) ≡ \\ [ \begin{matrix}( 1 + j \overline{g} ) ( \begin{matrix}{x}^{( 8 )} ( i ) + \\ {x}^{( 9 )} ( i ) g\end{matrix} ) & & ( 1 + j \overline{g} ) ( \begin{matrix}{x}^{( 10 )} ( i ) + \\ {x}^{( 11 )} ( i ) g\end{matrix} ) & & & \\ ( 1 + jg ) ( \begin{matrix}{x}^{( 10 )} ( i ) + \\ {x}^{( 11 )} ( i ) \overline{g}\end{matrix} ) & & ( 1 + jg ) ( \begin{matrix}{x}^{( 8 )} ( i ) + \\ {x}^{( 9 )} ( i ) \overline{g}\end{matrix} ) & & 0 & \\ & 0 & & ( 1 + j \overline{g} ) ( \begin{matrix}{x}^{( 12 )} ( i ) + \\ {x}^{( 13 )} ( i ) g\end{matrix} ) & & ( 1 + j \overline{g} ) ( \begin{matrix}{x}^{( 14 )} ( i ) + \\ {x}^{( 15 )} ( i ) g\end{matrix} ) \\ & & & ( 1 + jg ) ( \begin{matrix}{x}^{( 14 )} ( i ) + \\ {x}^{( 15 )} ( i ) \overline{g}\end{matrix} ) & & ( 1 + jg ) ( \begin{matrix}{x}^{( 12 )} ( i ) + \\ {x}^{( 13 )} ( i ) \overline{g}\end{matrix} )\end{matrix} ] . & [ Eqn . 44 ]\end{matrix}$$

In Equations 43 and 44, i=0,1, . . . , M_{symb}^{ap}−1, M_{symb}^{ap}=8M_{symb}^{layer}, j=\sqrt{−1}, g is the Golden number, i.e.,

$$g = \frac{1 + \sqrt{5}}{2} and \overline{g} = 1 - g = \frac{1 - \sqrt{5}}{2} .$$

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communications network, a transmission diversity device comprising:
a number of antenna ports;
a layer mapper configured to map a plurality of modulation symbols onto at least one layer; and
a precoder configured to perform transmit diversity on the at least one layer, wherein an output of the precoder is obtained by at least one of Equation 1, Equation 2, an 8TxD equation, and wherein Equation 1 is:
$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 2} ( i ) \\ ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} k} & - {( {x}^{( 1 )} ( i ) )}^{*} {e}^{j {θ}_{1} k} \\ {x}^{( 1 )} ( i ) {e}^{j ( {θ}_{2} k + φ )} & {( {x}^{( 0 )} ( i ) )}^{*} {e}^{j ( {θ}_{2} k + φ )}\end{matrix} ] ;\end{matrix}$$
Equation 2 is:
$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 3} ( i ) \\ ≡ \frac{1}{\sqrt{4}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] .\end{matrix}$$

2. The transmission diversity device as set forth in claim 1, wherein the layer mapper is one of a 2-layer mapper, 4-layer mapper, 6-layer mapper, 8-layer mapper and 16-layer mapper.

3. The transmission diversity device as set forth in claim 1, wherein the precoder is one of 4-TxD SFBC-PSD precoder, an 8-TxD1 precoder, an 8-TxD1′ precoder, an 8-TxD2 precoder, an 8-TxD3 precoder, an 8-TxD3′ precoder, an 8-TxD4 precoder, an 8-TxD5 precoder; SFBC-FSTD precoder; QO-SFBC; and SFBC-CDD.

4. The transmission diversity device as set forth in claim 1, wherein the output of the precoder is defined by the 8TxD equation, wherein the 8TxD equation is
$${X}_{8 T \times D} = [ \begin{matrix}{X}_{1} & {X}_{2} \\ {X}_{3} & {X}_{4}\end{matrix} ] ,$$
and wherein X₁, X₂, X₃ and X₄ are each defined by at least one of Equations 1 and 2.

5. The transmission diversity device as set forth in claim 1, wherein the output of the precoder is defined by the 8TxD equation, wherein the 8TxD equation is
$${X}_{8 T \times D 1} = [ \begin{matrix}{X}_{1} & {0}_{4 \times 2} \\ {0}_{4 \times 2} & {X}_{4}\end{matrix} ] ,$$
and wherein X₁ and X₄ are each defined by at least one of Equation 1 and Equation 2.

6. The transmission diversity device as set forth in claim 1, wherein the output of the precoder is defined by an 8TxD equation, wherein the 8TxD equation is
$${X}_{8 T \times D 4} = [ \begin{matrix}{X}_{1} & {0}_{4 \times 4} \\ {0}_{4 \times 4} & {X}_{4}\end{matrix} ] ,$$
X₁ and X₄ are each defined by Equation 3, and wherein Equation 3 is:
$$[ \begin{matrix}{y}^{( 0 )} ( 4 i ) & {y}^{( 0 )} ( 4 i + 1 ) & {y}^{( 0 )} ( 4 i + 2 ) & {y}^{( 0 )} ( 4 i + 3 ) \\ {y}^{( 1 )} ( 4 i ) & {y}^{( 1 )} ( 4 i + 1 ) & {y}^{( 1 )} ( 4 i + 2 ) & {y}^{( 1 )} ( 4 i + 3 ) \\ {y}^{( 2 )} ( 4 i ) & {y}^{( 2 )} ( 4 i + 1 ) & {y}^{( 2 )} ( 4 i + 2 ) & {y}^{( 2 )} ( 4 i + 3 ) \\ {y}^{( 3 )} ( 4 i ) & {y}^{( 3 )} ( 4 i + 1 ) & {y}^{( 3 )} ( 4 i + 2 ) & {y}^{( 3 )} ( 4 i + 3 )\end{matrix} ] = {X}_{S F B C \text{-} F S T D} ( i ) ≡ \frac{1}{\sqrt{2}} [ \begin{matrix}{x}^{( 0 )} ( i ) & {x}^{( 1 )} ( i ) & 0 & 0 \\ 0 & 0 & {x}^{( 2 )} ( i ) & {x}^{( 3 )} ( i ) \\ - {( {x}^{( 1 )} ( i ) )}^{*} & {( {x}^{( 0 )} ( i ) )}^{*} & 0 & 0 \\ 0 & 0 & - {( {x}^{( 3 )} ( i ) )}^{*} & {( {x}^{( 2 )} ( i ) )}^{*}\end{matrix} ] ..$$

7. The transmission diversity device as set forth in claim 1, wherein the output of the precoder is obtained by row permutation of at least one of Equation 1 and Equation 2.

8. A method for transmission in a wireless communications network, the method comprising:
mapping a plurality of modulation symbols onto at least one layer; and
preceding the at least one layer using at least one of Equation 1, Equation 2, and an 8TxD equation, and wherein Equation 1 is:
$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 2} ( i ) \\ ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} k} & - {( {x}^{( 1 )} ( i ) )}^{*} {e}^{j {θ}_{1} k} \\ {x}^{( 1 )} ( i ) {e}^{j ( {θ}_{2} k + φ )} & {( {x}^{( 0 )} ( i ) )}^{*} {e}^{j ( {θ}_{2} k + φ )}\end{matrix} ] ;\end{matrix}$$
Equation 2 is:
$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 3} ( i ) \\ ≡ \frac{1}{\sqrt{4}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] .\end{matrix}$$

9. The method as set forth in claim 8, wherein mapping comprises one of a 2-layer mapping, 4-layer mapping, 6-layer mapping, 8-layer mapping and 16-layer mapping.

10. The method as set forth in claim 8, wherein preceding is performed by one of a 4-TxD SFBC-PSD precoder, an 8-TxD1 precoder, an 8-TxD1′ precoder, an 8-TxD2 precoder, an 8-TxD3 precoder, an 8-TxD3′ precoder, an 8-TxD4 precoder, an 8-TxD5 precoder, SFBC-FSTD precoder; QO-SFBC; and SFBC-CDD.

11. The method as set forth in claim 8, wherein preceding further comprises using the 8TxD equation, wherein the 8TxD equation is
$${X}_{8 T \times D } = [ \begin{matrix}{X}_{1} & {X}_{2} \\ {X}_{3} & {X}_{4}\end{matrix} ] ,$$
and wherein X₁, X₂, X₃ and X₄ are each defined by at least one of Equations 1 and 2.

12. The method as set forth in claim 8, wherein precoding further comprises using an 8TxD equation, wherein the 8TxD equation is
$${X}_{8 T \times D 1} = [ \begin{matrix}{X}_{1} & {0}_{4 \times 2} \\ {0}_{4 \times 2} & {X}_{4}\end{matrix} ] ,$$
and wherein X₁ and X₄ are each defined by at least one of Equation 1 and Equation 2.

13. The method as set forth in claim 8, wherein preceding further comprises using the 8TxD equation, wherein the 8TxD equation is
$${X}_{8 T \times D 4} = [ \begin{matrix}{X}_{1} & {0}_{4 \times 4} \\ {0}_{4 \times 4} & {X}_{4}\end{matrix} ] ,$$
X₁ and X₄ are each defined by Equation 3 and wherein Equation 3 is:
$$[ \begin{matrix}{y}^{( 0 )} ( 4 i ) & {y}^{( 0 )} ( 4 i + 1 ) & {y}^{( 0 )} ( 4 i + 2 ) & {y}^{( 0 )} ( 4 i + 3 ) \\ {y}^{( 1 )} ( 4 i ) & {y}^{( 1 )} ( 4 i + 1 ) & {y}^{( 1 )} ( 4 i + 2 ) & {y}^{( 1 )} ( 4 i + 3 ) \\ {y}^{( 2 )} ( 4 i ) & {y}^{( 2 )} ( 4 i + 1 ) & {y}^{( 2 )} ( 4 i + 2 ) & {y}^{( 2 )} ( 4 i + 3 ) \\ {y}^{( 3 )} ( 4 i ) & {y}^{( 3 )} ( 4 i + 1 ) & {y}^{( 3 )} ( 4 i + 2 ) & {y}^{( 3 )} ( 4 i + 3 )\end{matrix} ] = {X}_{S F B C \text{-} F S T D} ( i ) ≡ \frac{1}{\sqrt{2}} [ \begin{matrix}{x}^{( 0 )} ( i ) & {x}^{( 1 )} ( i ) & 0 & 0 \\ 0 & 0 & {x}^{( 2 )} ( i ) & {x}^{( 3 )} ( i ) \\ - {( {x}^{( 1 )} ( i ) )}^{*} & {( {x}^{( 0 )} ( i ) )}^{*} & 0 & 0 \\ 0 & 0 & - {( {x}^{( 3 )} ( i ) )}^{*} & {( {x}^{( 2 )} ( i ) )}^{*}\end{matrix} ] .$$

14. The method as set forth in claim 8, wherein the step of precoding further comprising using an equation obtained by row permutation of at least one of Equation 1 and Equation 2.

15. A wireless communications network comprising a plurality of base stations capable of diversity transmissions with a plurality of subscriber stations, wherein at least one of the plurality of subscriber stations comprising:
a number of antenna ports;
a layer mapper configured to map a plurality of modulation symbols onto at least one layer; and
a precoder configured to perform transmit diversity on the at least one layer, wherein an output of the precoder is obtained by at least one of Equation 1, Equation 2, and an 8TxD equation, and wherein Equation 1 is:
$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 2} ( i ) \\ ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} k} & - {( {x}^{( 1 )} ( i ) )}^{*} {e}^{j {θ}_{1} k} \\ {x}^{( 1 )} ( i ) {e}^{j ( {θ}_{2} k + φ )} & {( {x}^{( 0 )} ( i ) )}^{*} {e}^{j ( {θ}_{2} k + φ )}\end{matrix} ] ; and\end{matrix}$$
Equation 2 is:
$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 3} ( i ) \\ ≡ \frac{1}{\sqrt{4}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] .\end{matrix}$$

16. The network as set forth in claim 15, wherein the output of the precoder is obtained by an 8TxD equation and wherein the 8TxD equation is
$${X}_{8 T \times D} = [ \begin{matrix}{X}_{1} & {X}_{2} \\ {X}_{3} & {X}_{4}\end{matrix} ]$$
and at least one of X₁, X₂, X₃ and X₄ is defined by at least one of Equations 1 and 2.

17. The network as set forth in claim 16, wherein the mapper is configured to map the plurality of modulation symbols to four layers and wherein X₂ and X₃ are zero matrices.

18. The network as set forth in claim 15, wherein the output of the precoder is obtained by row permutation of at least one of Equation 1 and Equation 2.

19. A method for wireless communications, the method comprising:
mapping a plurality of modulation symbols onto at least one layer; and
preceding the at least one layer using an 8TxD equation, and wherein one or more of X₁, X₂, X₃ and X₄ is defined by at least one of Equation 1, Equation 2, and wherein Equation 1 is:
$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 2} ( i ) \\ ≡ \frac{1}{\sqrt{4}} [ \begin{matrix}{x}^{( 0 )} ( i ) & - {( {x}^{( 1 )} ( i ) )}^{*} \\ {x}^{( 1 )} ( i ) & {( {x}^{( 0 )} ( i ) )}^{*} \\ {x}^{( 0 )} ( i ) {e}^{j {θ}_{1} k} & - {( {x}^{( 1 )} ( i ) )}^{*} {e}^{j {θ}_{1} k} \\ {x}^{( 1 )} ( i ) {e}^{j ( {θ}_{2} k + φ )} & {( {x}^{( 0 )} ( i ) )}^{*} {e}^{j ( {θ}_{2} k + φ )}\end{matrix} ] ; and\end{matrix}$$
Equation 2 is:
$$\begin{matrix}[ \begin{matrix}{y}^{( 0 )} ( 2 i ) & {y}^{( 0 )} ( 2 i + 1 ) \\ {y}^{( 1 )} ( 2 i ) & {y}^{( 1 )} ( 2 i + 1 ) \\ {y}^{( 2 )} ( 2 i ) & {y}^{( 2 )} ( 2 i + 1 ) \\ {y}^{( 3 )} ( 2 i ) & {y}^{( 3 )} ( 2 i + 1 )\end{matrix} ] = {X}_{S F B C \text{-} P S D 3} ( i ) \\ ≡ \frac{1}{\sqrt{4}} [ \begin{matrix}{x}^{( 0 )} ( i ) & {x}^{( 1 )} ( i ) \\ - {( {x}^{( 1 )} ( i ) )}^{*} & {( {x}^{( 0 )} ( i ) )}^{*} \\ {x}^{( 0 )} ( i ) {e}^{j {θ}_{1} k} & - {x}^{( 1 )} ( i ) {e}^{j {θ}_{1} k} \\ - {( {x}^{( 1 )} ( i ) )}^{*} {e}^{j ( {θ}_{2} k + φ )} & {( {x}^{( 0 )} ( i ) )}^{*} {e}^{j ( {θ}_{2} k + φ )}\end{matrix} ] .\end{matrix}$$

20. The method of claim 19, wherein the 8TxD equation is one of
$${X}_{8 T \times D} = [ \begin{matrix}{X}_{1} & {X}_{2} \\ {X}_{3} & {X}_{4}\end{matrix} ] , \\ {X}_{8 T \times D 1} = [ \begin{matrix}{X}_{1} & {0}_{4 \times 2} \\ {0}_{4 \times 2} & {X}_{4}\end{matrix} ] , \\ {X}_{8 T \times D 3} = [ \begin{matrix}{X}_{1} & {0}_{4 \times 2} \\ {0}_{4 \times 4} & {X}_{4}\end{matrix} ] . , \\ {X}_{8 T \times D 3}^{′} = [ \begin{matrix}{X}_{1} & {0}_{4 \times 4} \\ {0}_{4 \times 2} & {X}_{4}\end{matrix} ] , \\ and$$
$${X}_{8 T \times D 4} = [ \begin{matrix}{X}_{1} & {0}_{4 \times 4} \\ {0}_{4 \times 4} & {X}_{4}\end{matrix} ] .$$
